(19) United States
(12) Patent Application Publication
(10) Pub. No.: US 2012/0164298 A1
(43) Pub. Date: Jun. 28, 2012

(54) DAIRY CONTAINING BEVERAGES WITH ENHANCED FLAVORS AND METHOD OF MAKING SAME

(75) Inventors: Urano A. Robinson, Sammamish, WA (US); J. Marcio Da Cruz, Issaquah, WA (US); Dien Van Vu, Kent, WA (US)

(73) Assignee: Starbucks Corporation D/B/A Starbucks Coffee Company, Seattle, WA (US)

(21) Appl. No.: 12/977,002

(22) Filed: Dec. 22, 2010

(51) Int. Cl. A23C 7/04; A01J 11/06; A23F 5/00; A23C 9/00

(52) U.S. Cl. 426/580; 426/491; 99/456

(57) ABSTRACT

The present embodiments generally relate to beverages with enhanced flavors and aromas and method of making same. Some embodiments of the present disclosure are directed to shelf-stable dairy products. Other embodiments are related to beverages with shelf-stable dairy products and soluble coffee. Also disclosed are methods of making the same.

### BACKGROUND

1. Field

The present embodiments generally relate to dairy containing beverages with enhanced qualities such as flavor and methods of making same.

2. Description of the Related Art

Many beverage components have a distinct taste and aroma that is difficult to duplicate in a more convenient form. One example of such a beverage component is dairy. Conventional dairy such as milk is often obtained as a liquid and provided to the consumer in a manner requiring limited processing. However, significantly more processing is required for products having a long shelf life such as instant beverages containing dairy, carbonated beverages, etc., some of which are desired in a form containing dairy. However, dairy is susceptible to contamination by microorganisms and is therefore subject to very strict guidelines of sterility. As such, for any dairy-containing product to be approved for sale for human consumption, it must be preserved robustly.

Many techniques for preserving dairy-containing products to yield a long shelf life have been attempted, most of which include pasteurization and heating the dairy product to high temperatures repeatedly and for long periods of time in order to kill organisms and prepare the dairy for efficient processing. Unfortunately, heating a dairy component to high temperatures, heating a dairy component multiple times or heating a dairy component for long periods of time causes molecular changes in the dairy product which lead to bitter or processed tastes which may decrease the appeal of the beverage. Moreover, many aromas and flavors associated with dairy are very delicate and complex. With conventional heating methods, delicate dairy flavors may be degraded or lost during processing and manufacturing methods. This degradation can substantially reduce the perceived quality of the product. For this reason, special attention should be paid to the preparation and storage of dairy components so that desirable aromas and flavors are enhanced and undesirable aromas and flavors are reduced or eliminated.

Furthermore, since instant beverages containing dairy are conventionally exposed repeatedly to high temperatures for long periods of time during preparation, the flavor and fragrance are degraded, producing a beverage with flavors and fragrances which are far from flavors and fragrances associated with fresh dairy-containing beverages. The shelf-stable dairy products of the present embodiments overcome these problems in the prior art as well as provide additional advantages.

### SUMMARY

The present embodiments relate to shelf-stable beverages, for example, self-stable beverages containing coffee components, dairy components, carbohydrate components, flavoring components and other ingredients. The preparation of dairy components in liquid or dry form is done in a manner which preserves taste, mouthfeel, aroma, color and consistency of the dairy product while rendering it substantially aseptic and therefore suitable for use in an instant product or a shelf-stable product.

The preparation of the dairy component comprises multiple steps such as filtering, concentrating, sterilizing, and drying. However, some embodiments may contain fewer steps, more steps, steps in different orders and/or steps in different combinations depending on the type of dairy starting materials used, their consistency and other characteristics. Many different combinations of filtering, concentrating, sterilizing and drying are discussed below and each can be done with a wide variety of variables in terms of, for example, the pore sizes of the filters in the filtering, the temperature and duration of the concentration, the temperature and pressure of the sterilizing, the type and temperature of drying, etc.

Filtration is useful when preparing a shelf-stable dairy component because it can provide a low heat or no heat method of removing bacteria and other contaminants from a dairy component. Avoiding excessive heating of a dairy component can help preserve taste, mouthfeel, aroma, color and consistency. Many different types of filters and filtration can be used alone in sequence, if desired. In some embodiments, the dairy component is subjected to repeated rounds of filtration between two different types of filtration depending on the desired outcome.

Concentration of beverage components can make the beverage component easier to process, filter, sterilize, transport and store. With a shelf-stable or instant beverage especially, it is advantageous to have the beverage in a more compact form. Concentration may be used in addition to, or in lieu of, filtration to remove unwanted materials from the dairy component. In fact, some methods of concentration include a filtration aspect, such as reverse osmosis concentration. With concentration, the focus is on removing excess water to reduce the bulk of the component and reduce the cost associated with further processing, transporting and storing of it.

Though filtration of a liquid can remove significant amounts of bacteria, in order for a liquid to be considered aseptic as required for shelf-stable products, additional sterilization methods are often required. Conventional methods of sterilization of dairy components expose the dairy component to very high temperatures, expose the dairy component to repeated heating, or both. Present embodiments provide a method including sterilization which does not heat the dairy component over a certain temperature or avoids the repeated heating of the dairy component. In this way, the taste, mouthfeel, aroma, color and consistency of a fresh dairy product can be preserved in shelf-stable and instant beverages.

As will be described in more detail below, some embodiments of the present disclosure relate to a process for preparing a liquid dairy component for use in a shelf-stable beverage that involves filtration, concentration and sterilization. Some other embodiments relate to a process for preparing a dry dairy component for use in a shelf-stable beverage that involves filtration, concentration, sterilization and drying.

### BRIEF DESCRIPTION OF THE DRAWINGS

FIG. 1 is a process flow diagram illustrating an overview of one embodiment of a method of making a coffee beverage with enhanced flavor and aroma.

FIG. 2 is a process flow diagram illustrating an overview of one embodiment of a method making a coffee beverage with enhanced flavor and aroma.

FIG. 3 is a process flow diagram illustrating an overview of one embodiment of a method of pulverizing a raw material in a refrigerated environment.

FIG. 4 is a process flow diagram illustrating an overview of one embodiment of a method of preparing a shelf-stable dairy product.

FIG. 5 is a process flow diagram illustrating an overview of one embodiment of a method of preparing a shelf-stable dairy product.

FIG. 6 is a process flow diagram illustrating an overview of one embodiment of preparing a shelf-stable dairy product.

FIG. 7 is a process flow diagram illustrating an overview of one embodiment of preparing a shelf-stable dairy product.

FIG. 8 is a process flow diagram illustrating an overview of one embodiment of preparing a shelf-stable coffee/dairy product.

FIG. 9 is a process flow diagram illustrating an overview of one embodiment of preparing a shelf-stable coffee/dairy product.

FIG. 10 is a process flow diagram illustrating an overview of one embodiment of preparing a shelf-stable liquid dairy product.

FIG. 11 is a process flow diagram illustrating an overview of one embodiment of preparing a shelf-stable dry dairy product.

FIG. 12 is a process flow diagram illustrating an overview of one embodiment of a method of pulverizing a raw material in a refrigerated environment.

### DETAILED DESCRIPTION

The following discussion is presented to enable a person skilled in the art to make and use one or more of the present embodiments. The general principles described herein may be applied to embodiments and applications other than those detailed below without departing from the spirit and scope of the disclosure. Therefore, the present embodiments are not intended to be limited to the particular embodiments shown, but are to be accorded the widest scope consistent with the principles and features disclosed or suggested herein.

Dairy is a common component in foods and beverages from all over the world; however, preserving dairy for use an extended period of time after its collection has proven to be difficult. Conventional shelf-stable dairy products have been prepared in attempts to approximate the flavor of fresh dairy but generally taste, smell and feel processed. The present embodiments provide a dairy product which tastes, feels and smells more like dairy that has been recently obtained. Some embodiments relate to liquid dairy components, such as, for example, liquid milk, liquid skim milk, liquid non-fat milk, liquid low fat milk, liquid whole milk, liquid half & half, liquid light cream, liquid light whipping cream, liquid heavy cream, liquid lactose free milk, liquid reduced lactose milk, liquid sodium free milk, liquid reduced sodium milk, liquid dairy fortified with nutrients, such as vitamins A, D, E, K, or calcium, liquid high protein dairy, liquid whey protein concentrate, liquid whey protein isolate, etc.

Some embodiments relate to dry dairy components, such as, for example, whole dry milk, non-fat dry milk, low fat milk powder, whole milk powder, dry whey solids, de-mineralized whey powders, individual whey protein, casein dairy powders, individual casein powders, anhydrous milkfat, dried cream, lactose free dairy powder, dry lactose derivatives, reduced sodium dairy powder, etc. The present embodiments also include calorie-free dairy, cholesterol free dairy, low calorie dairy, low cholesterol dairy, light dairy, etc. Also included are combinations of any of the above liquid or dry dairy components in any ratio.

In order for a dairy product to be shelf-stable and meet regulatory standards, it should be aseptic. In the past, pasteurization has been used to render dairy products aseptic, but the high heat involved with pasteurization (heating to a temperature of 145° F. and above) and repeated heating steps cause the dairy to take on a processed taste that is undesirable. However, dairy that is not heated over a certain temperature or not heated repeatedly typically does not have this processed taste. The present embodiments relate to shelf-stable beverages and methods of making the same which do not have a processed taste. A shelf-stable beverage typically can be stored at ambient temperature for at least 6 months and up to 18 months, without developing an objectionable taste, mouthfeel, aroma, color or consistency.

As described above, exposure to high heat or repeated exposure to heat in a sterilization process can lead to undesirable qualities in a dairy-containing beverage. However, in order to be shelf-stable, the beverage should be substantially free of microorganisms. One method of removing such microorganisms and other contaminants which can be done without high heat or repeated heating is filtration. Different types of filtration can be used with or without heat to remove bacteria, excess water, high molecular weight proteins and other contaminants from liquids. Accordingly, dairy components can be filtered using membrane filtration as a no heat or low heat alternative method of removing unwanted bacteria and other contaminants.

Examples of materials used for such membrane filters include cellulose acetates, ceramics, cellulose esters, polyamides, etc. The types of filtration are not limited and include, for example, nanofiltration, ultrafiltration, microfiltration, reverse osmosis filtration, and any combination of these. Membrane filters can be obtained from Koch Filter Corporation (Louisville, Ky.) or Millipore Inc. (Billerica, Mass.), for example. Examples of suitable membrane filters are Romicon® made by Koch or Amicon® made by Millipore. Pore diameters of such filters may be from about 0.005 microns to about 0.5 microns and from about <1K to about 500K MWCO (Molecular Weight Cut-Off). In some embodiments, the dairy component is filtered using microfiltration to remove bacteria, protein and high molecular weight particles. In other embodiments a combination of filtration methods such as reverse osmosis, nanofiltration, ultrafiltration and microfiltration is used. Membrane filters can also be used in the present embodiments to concentrate solutions and remove water, salts and proteins, for example. After filtration of a dairy component, the materials such as bacteria and high molecular weight proteins blocked by the filter can be maintained or discarded. The liquid passing through the filter is usually maintained as the product of the filtration. In some embodiments, the dairy component contains significantly less bacteria and other contaminants after being subjected to a filtration process.

In order to facilitate filtration and other processing of a dairy component, the dairy component can be concentrated by removing water and salts, for example. In addition, concentration of beverage components can make the beverage component easier to process, sterilize, transport and store. In some embodiments, the dairy component can be concentrated using the above-described filtration techniques. In other embodiments, the dairy component can be concentrated using other techniques, such as freeze concentration. Freeze concentration involves concentration by partial freezing of the liquid dairy component and subsequent separation of the resulting ice crystals leaving a liquid concentrate. Other methods of concentration include low temperature/low pressure gentle thermal evaporation and high vacuum, low temperature evaporation, for example. Some embodiments relate to concentration through a combination of the above methods. In some embodiments, the dairy component can be concentrated through a combination of membrane filtration and non-membrane concentration. For example, concentration of the dairy component can be carried out through a combination of reverse osmosis filtration and freeze concentration. In other embodiments, the dairy component can be concentrated through a combination of different types of filtration such as ultra filtration and reverse osmosis filtration. In still other embodiments, the dairy component can be concentrated through a combination of more than one non-filtration techniques such as a combination of freeze concentration and low temperature/low pressure gentle thermal evaporation.

Some embodiments relate to dairy components in liquid form. Other embodiments relate to dairy products in dried or powder form. As with filtering, concentrating and sterilizing discussed above, drying of the dairy product, if performed, should be done in a manner which enhances the taste, mouthfeel, aroma, color and consistency of the dairy component. Drying the dairy component should be done carefully to avoid exposure to high heat, repeated heating or oxygen which could damage the taste and aroma of the dairy component. Also, care should be taken when drying to avoid any conditions which may contaminate the dairy component with bacteria or other contaminants. Examples of methods of drying a dairy component include freeze drying, spray drying, filter-mat drying, fluid bed drying, vacuum drying, drum drying, zeodration, etc, or any combination thereof. Zeodration involves drying with zeolites. Zeolites are materials containing pores which allow the passage of water but do not allow the passage of certain other materials. Drying by zeodration involves placing the wet solution in contact with zeolites, drawing only the water into the zeolites and then removing the zeolites, leaving a dried product.

In some embodiments, vacuum drying can be carried out at from about 10 mbar to about 40 mbar at a temperature of from about −20° C. to about 0° C. Freeze drying can be carried out at from about 0.5 mbar to about 50 mbar and at a temperature of from about −20° C. to about 0° C. In addition, if water is to be removed by sublimation, the pressure during freeze drying may be below about 6 mbar and the temperature below about 0° C. In some embodiments, zeodration can be carried out at a pressure of from about 0.1 to about 50 mbar and a temperature of from about 10° C. to about 60° C. Temperature and pressure ranges can be monitored carefully to obtain sublimation of water only which leaves intact the product flavor compounds. In one example, a dairy component can be dried at a temperature lower than about −11° C. to preserve substantially all flavor properties. In some embodiments, the temperature can be below about 0° C. until the last stage of the drying (for example, from about 5% to about 8% moisture) and the product temperature can then be raised above about 0° C. In some embodiments, the length of time that the dairy component undergoes drying is minimized to avoid degradation of flavor.

In addition, some embodiments relate to methods of keeping the dairy component aseptic and cool throughout the majority of processing. Such methods further help to prevent the dairy product from encountering unnecessary heat, oxygen and bacteria which can have negative effects on taste, mouthfeel, aroma, color and consistency of the dairy product. Such methods include refrigeration of machinery and gases coming into contact with the dairy component during filtration, concentration and packaging, for example. In addition, near aseptic packaging, substantially aseptic packaging and aseptic packaging can be used to package the dairy product directly after processing to minimize exposure to heat and microorganisms.

In some embodiments, a liquid dairy product can be prepared that tastes more like a fresh dairy product than conventional processed and preserved dairy products. Some methods of achieving such a dairy product involve filtering, concentrating and sterilizing a raw unpasteurized dairy component without pasteurizing the dairy component. Other methods involve filtering, concentrating and sterilizing an unpasteurized dairy component without heating the dairy component above about 145° F., above about 144° F., above about 143° F., above about 142° F., above about 141° F., above about 140° F., above about 139° F., above about 138° F., above about 137° F., above about 136° F., above about 135° F., above about 133° F., above about 130° F., above about 127° F., above about 125° F., above about 123° F., above about 122° F., above about 121° F. above about 120° F., above about 119° F. above about 118° F., above about 117° F., above about 116° F., above about 115° F., above about 110° F., above about 100° F., above about 90° F., above about 80° F., above about 70° F., or above about 60° F. The fact that the dairy component is not heated above a certain temperature allows the dairy component to retain its original taste, aroma and feel, thereby achieving a shelf-stable dairy product which tastes, feels and smells more like a fresh dairy product and less like a processed dairy product.

Some embodiments relate to preparing a dry dairy product that tastes more like a fresh dairy product than conventional processed and preserved dry dairy products. Some methods of achieving such a dairy product involve concentrating, sterilizing and drying a raw unpasteurized dairy component without heating the dairy component above about 80° F. more than one time, above about 77° F. more than one time, above about 75° F. more than one time, above about 70° F. more than one time, above about 65° F. more than one time, above about 60° F. more than one time, above about 65° F. more than one time, above about 60° F. more than one time, above about 55° F. more than one time, above about 50° F. more than one time, above about 45° F. more than one time, above about 40° F. more than one time, above about 35° F. more than one time, or above about 30° F. more than one time.

Though filtration of a liquid can remove significant amounts of bacteria, in order for a liquid to be considered aseptic as required for shelf-stable products, additional sterilization methods are often required. Sterilization of the dairy component can be carried out in many different ways, however, methods which do not heat the dairy component over a certain temperature and methods which involve minimal or no repeated heating over a certain temperature often result in more desirable qualities of a dairy-containing beverage such as taste, mouthfeel, aroma, color and consistency. Examples of such sterilization include high pressure sterilization (HP), high temperature short time (HTST) pasteurization, pressure assisted thermal sterilization (PATS) and thermal assisted pressure sterilization (TAPS). When TAPS is performed, many of the bacteria in the liquid are killed by the increased pressure of the process. Therefore, with a properly filtered, concentrated and otherwise prepared dairy component, TAPS can often result in an aseptic product which has not been heated over a certain temperature. In some embodiments, TAPS can be performed at a temperature of from about 60° F. to about 150° F., a pressure of from about 3000 bar to about 9000 bar and for a time from about 30 seconds to about 10 minutes. In other embodiments, TAPS can be performed at a temperature of from about 80° F. to about 140° F., a pressure of from about 3000 bar to about 9000 bar and for a time from about 1 minute to about 6 minutes. PATS involves bringing the dairy component to a high temperature, however, in contrast with conventional sterilization methods, PATS may only heat the dairy component over a certain temperature one time which results more desirable qualities of a dairy-containing beverage such as taste, mouthfeel, aroma, color and consistency. PATS can be performed at a temperature of from about 250° F. to about 350° F., a pressure of from about 3000 bar to about 9000 bar and for a time from about 30 seconds to about 10 minutes.

The above-described methods of processing a dairy component can be performed in many different combinations and with a wide variety of variables. For example, in some embodiments all of filtration, concentration, sterilization and drying are used in the preparation of a shelf-stable dairy-containing beverage. In other embodiments, only filtration, concentration and sterilization are used. In still other embodiments, only filtration and concentration are used. In yet other embodiments, only concentration and drying are used. In some embodiments, concentration, sterilization and drying are used.

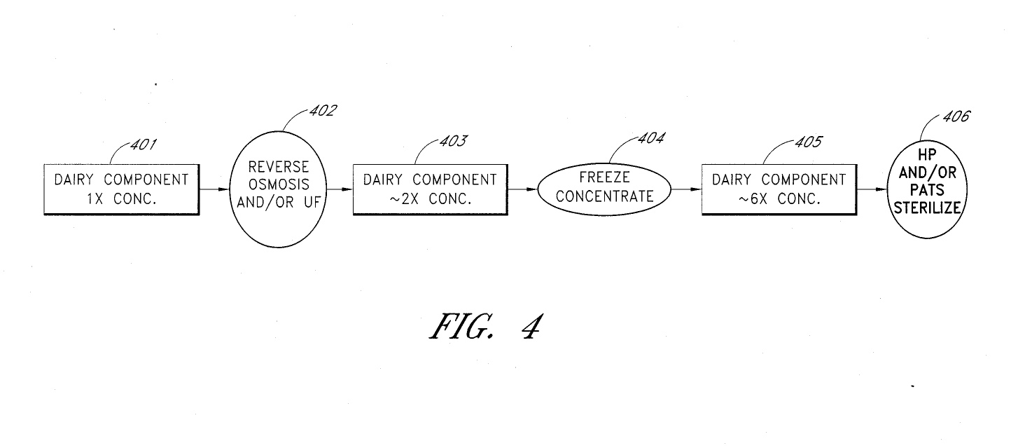

FIGS. 4-11 below illustrate example embodiments in which particular combinations and variables are used. However, the following are in no way meant to limit the scope of the present embodiments which cover modifications and equivalent arrangements included within the spirit and scope of the appended claims. It should be understood that the concentrations disclosed below are for illustrative purposes and may vary without departing from the scope of the present disclosure. Each example embodiment will be addressed in turn below with reference to the accompanying figures.

FIG. 4 shows an overview of one embodiment of a method of preparing a shelf-stable dairy product. In this embodiment, filtration, concentration and drying are performed on the dairy component. Example concentrations are shown. Referring to FIG. 4, a dairy component at a 1× concentration shown in block 401 is subjected to reverse osmosis concentration and/or ultrafiltration (UF) as shown in block 402. Depending on the conditions and desired outcome, just one of reverse osmosis concentration and ultrafiltration can be performed on the dairy component or both can be carried out. In some embodiments, nanofiltration, microfiltration or a combination thereof is also performed on the dairy component at the 1× concentration. The reverse osmosis concentration and/or ultrafiltration of the dairy component at the 1× concentration results in a dairy component that is for example at an about 2× concentration shown in block 403. Freeze concentration is then performed on the about 2× concentrated dairy component as shown in block 404 to produce the dairy component at an about 6× concentration, for example, as shown in block 405. Freeze concentration may be successful in concentrating the dairy component to a 6× or greater concentration where other methods such as reverse osmosis are not. Depending on the desired level of concentration, different methods of concentration can be repeated and combined in many different ways. The dairy component at the about 6× concentration is then subjected to sterilization in block 406 which can be high pressure sterilization (HP), thermal assisted pressure sterilization (TAPS) or a combination thereof. After the above example process, the dairy component may undergo further processing or may be ready for final packaging.

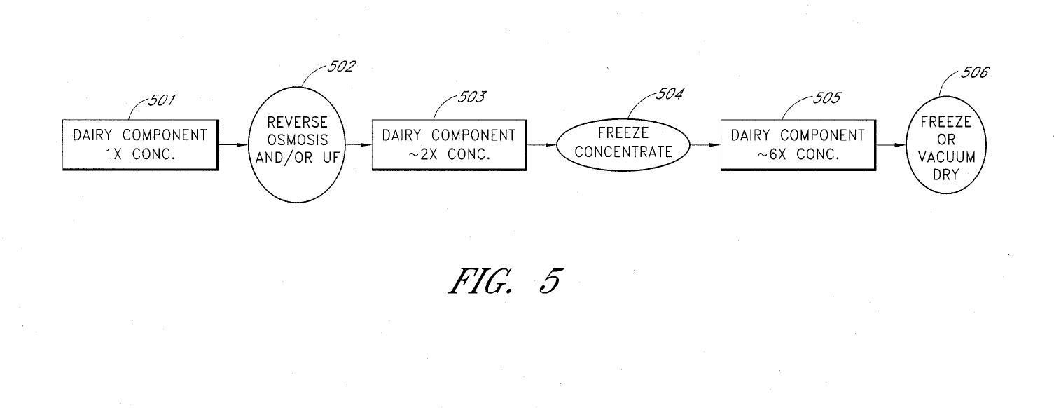

FIG. 5 shows another example process similar to the one shown in FIG. 4 but differing in that the dairy component is dried after concentration and optional filtration rather than subject to sterilization. Such a process can be useful in preparing a dry powder dairy component. In the example embodiment shown in FIG. 5, a dairy component at a 1× concentration shown in block 501 is subjected to reverse osmosis concentration and/or ultrafiltration as shown in block 502. Depending on the conditions and desired outcome, just one of reverse osmosis concentration and ultrafiltration can be performed on the dairy component or both can be carried out. In some embodiments, nanofiltration, microfiltration or a combination thereof is also performed on the dairy component at 1× concentration. The reverse osmosis concentration and/or microfiltration results in a dairy component that is at an about 2× concentration, for example, shown in block 503. Freeze concentration is then performed on the about 2× concentrated dairy component as shown in block 504 to produce the dairy component at an about 6× concentration, for example, as shown in block 505. The dairy component at the about 6× concentration then can undergo at least one of freeze drying, spray drying, filter-mat drying, fluid bed drying, vacuum drying, drum drying, zeodration, etc as shown in block 506. After the above example process, the dairy component may undergo further processing or may be ready for final packaging.

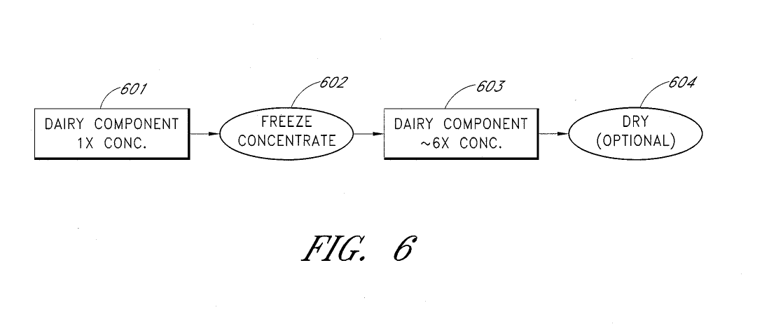

FIG. 6 shows an overview of another embodiment of a method of preparing a shelf-stable dairy product in which only freeze concentration and an optional drying state are included. This method may be an intermediate step in a larger method. In this embodiment, a dairy component at a 1× concentration shown in block 601 is subjected to freeze concentration as shown in block 602 to produce the dairy component at an about 6× concentration as shown in block 603. The dairy component at the about 6× concentration then can optionally undergo at least one of freeze drying, spray drying, filter-mat drying, fluid bed drying, vacuum drying, drum drying, zeodration, etc. as shown in block 604. After the above example process, the dairy component may undergo further processing or may be ready for final packaging.

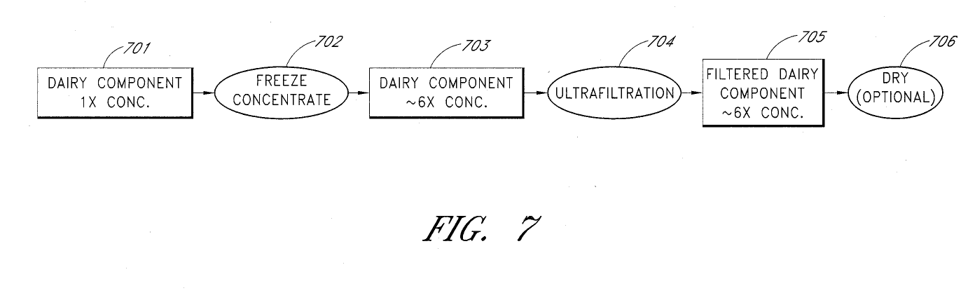

FIG. 7 shows an overview of another embodiment of a method of preparing a shelf-stable dairy product in which concentration, filtration and an optional drying step are performed. In this embodiment, freeze concentration is used but reverse osmosis is not. Depending on the type of dairy component, its consistency and other properties, different processes and combinations of processes may be performed. This method may also be a standalone method of preparing a shelf-stable dairy component or may be part of a larger method. In this embodiment, a dairy component at 1× concentration shown in block 701 is subjected to freeze concentration as shown in block 702. The freeze concentration results in a dairy component that is at an about 6× concentration, for example, shown in block 703. Ultrafiltration is then performed on the about 6× concentrated dairy component as shown in block 704 to produce a filtered dairy component at an about 6× concentration as shown in block 705. The filtered dairy component at the about 6× concentration can then undergo at least one of freeze drying, spray drying, filter-mat drying, fluid bed drying, vacuum drying, drum drying, zeodration, etc. as shown in block 706. After the above example process, the dairy component may undergo further processing or may be ready for final packaging.

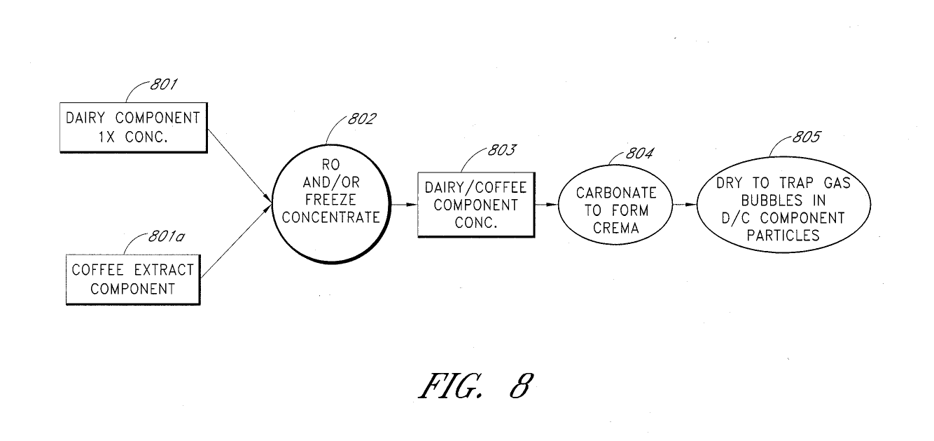

Some embodiments relate to the preparation of a beverage containing both a coffee component and a dairy component. When two components such as coffee and dairy are combined, some or all of the above-described filtration, concentration, sterilization and drying methods can be performed on both of the components at the same time. FIG. 8 shows an overview of one embodiment of preparing a shelf-stable coffee/dairy product where a dairy component at 1× concentration shown in block 801 and a coffee extract component shown in block 801a are combined to form a dairy/coffee combination (D/C component) and subjected to reverse osmosis concentration and/or freeze concentration as shown in block 802. In some embodiments, nanofiltration, microfiltration or a combination thereof is also performed on the combined coffee extract component and dairy component at 1× concentration. The reverse osmosis and/or freeze concentration results in a concentrated dairy/coffee component shown in block 803. The concentrated dairy/coffee component can then be carbonated or treated with gas to form a crema as shown in block 804. In some embodiments, the gas can be a mixture of gases. In some embodiments, the gas can be one or more inert gases. In some embodiments the gas can be air. The resulting mixture can then be dried by any method that effectively traps the gas in the dairy/coffee particles as shown in block 805, for example, at least one of freeze drying, spray drying, filter-mat drying, fluid bed drying, vacuum drying, drum drying, zeodration, etc. After the above example process, the dairy component may undergo further processing or may be ready for final packaging.

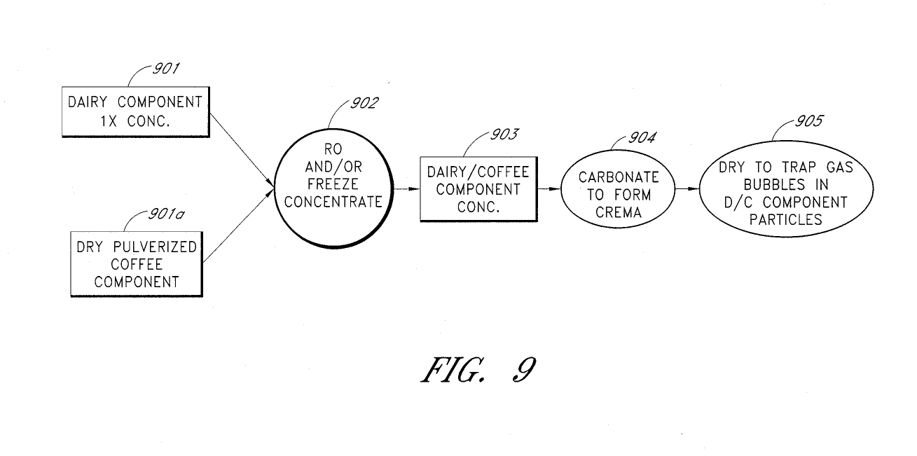

FIG. 9 shows an overview of a method similar to the one shown in FIG. 8 described above. The major difference shown is that a dry pulverized coffee component is combined initially with the dairy component. As is discussed in more detail below, the present embodiments cover many methods of introducing pulverized coffee to dairy components, coffee extract components, carbohydrate components and flavoring components, for example, at many different stages of processing. Referring to FIG. 9 a dairy component at a 1× concentration shown in block 901 and a pulverized coffee component shown in block 901a are combined and subjected to reverse osmosis concentration and/or freeze concentration as shown in block 902. In some embodiments, nanofiltration, microfiltration or a combination thereof is also performed on the combined coffee extract component and dairy component at 1× concentration. The reverse osmosis and/or freeze concentration results in a concentrated dairy/coffee component shown in block 903. The concentrated dairy/coffee component can then be carbonated or treated with gas to form a crema as shown in block 904. In some embodiments, the gas can be a mixture of gases. In some embodiments, the gas can be one or more inert gases. In some embodiments the gas can be air. The resulting mixture can then be dried by any method that effectively traps the gas bubbles in the dairy/coffee particles as shown in block 905, for example, at least one of freeze drying, spray drying, filter-mat drying, fluid bed drying, vacuum drying, drum drying, zeodration, etc. After the above example process, the dairy component may undergo further processing or may be ready for final packaging.

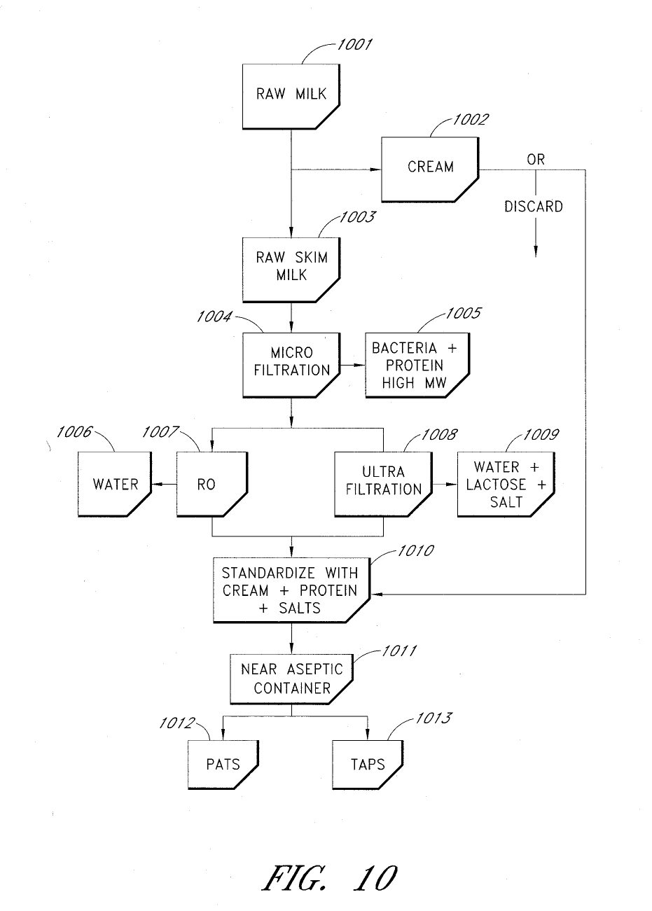

Some embodiments relate to the preparation of liquid dairy components while other embodiments relate to the preparation of dry dairy components. In FIG. 10, the preparation of a liquid dairy component is shown. FIG. 10 shows an overview of an example embodiment in which a raw dairy product is subjected to filtration, concentration and sterilization. Further, FIG. 10 shows the separation of the dairy into an aqueous subcomponent and a fat subcomponent. In the embodiment shown, the aqueous subcomponent undergoes filtration and concentration, while the fat subcomponent does not. If the fat subcomponent is recombined with the aqueous subcomponent after it has been filtered and concentrated, then the combination undergoes sterilization. Referring to FIG. 10, a raw unpasteurized dairy component (such as raw milk) shown in block 1001 is separated into an aqueous subcomponent (such as raw skim milk) shown in block 1003 and a fat subcomponent (such as cream) shown in block 1002. The fat subcomponent can be discarded at this stage or recombined with the aqueous subcomponent as shown in block 1010 after the aqueous subcomponent has undergone concentration and filtration. The aqueous subcomponent is concentrated using, for example, microfiltration as shown in block 1004 to remove bacteria and protein with a high molecular weight as shown in block 1005. The aqueous subcomponent is then concentrated by, for example, reverse osmosis as shown in block 1007 and ultrafiltration as shown in block 1008. Reverse osmosis of the aqueous subcomponent results in a concentrated aqueous subcomponent which is maintained and water shown in block 1006 which can be discarded. Ultrafiltration of the aqueous subcomponent results in a concentrated aqueous subcomponent which is maintained and water, lactose and salt shown in block 1109 which can be discarded. In some embodiments, the aqueous subcomponent can be subjected to repeated rounds of filtration and concentration and more than one method of filtration and concentration can be used. The aqueous subcomponent can be standardized as shown in block 1010 with at least one of protein, salts and a dairy fat subcomponent such as cream. The fat subcomponent used to standardize the aqueous component may be the fat subcomponent shown in block 1002 or may be a fat subcomponent introduced from another source. In other embodiments, the aqueous subcomponent is standardized without a fat subcomponent but with protein and salts. In still another embodiment, the aqueous subcomponent standardized only with a fat subcomponent. The aqueous subcomponent can then be transferred to a near aseptic, substantially aseptic or aseptic container as shown in block 1011.

The aqueous subcomponent can then be sterilized. In some embodiments the sterilization can be at least one of PATS as shown in block 1012 and TAPS as shown in block 1013. TAPS can be performed at a temperature of from about 60° F. to about 140° F., a pressure of from about 3000 bar to about 9000 bar and for a time from about 30 seconds to about 10 minutes. PATS can be performed at a temperature of from about 250° F. to about 350° F., a pressure of from about 3000 bar to about 9000 bar and for a time from about 30 seconds to about 10 minutes After sterilization, the liquid dairy product can be packaged (not shown). In some embodiments, the packaging is done in a manner which prevents contact with air, oxygen, bacteria, heat or any other substance or condition which could damage or contaminate the liquid dairy product. In some embodiments, aseptic packaging techniques are utilized, for example, nitrogen purging, vacuum packaging, etc. Also, liquid nitrogen or any other oxygen scavengers can be used during packaging to minimize the degradative effects of oxygen. After the above example process, the dairy component may undergo further processing or may be ready for final packaging.

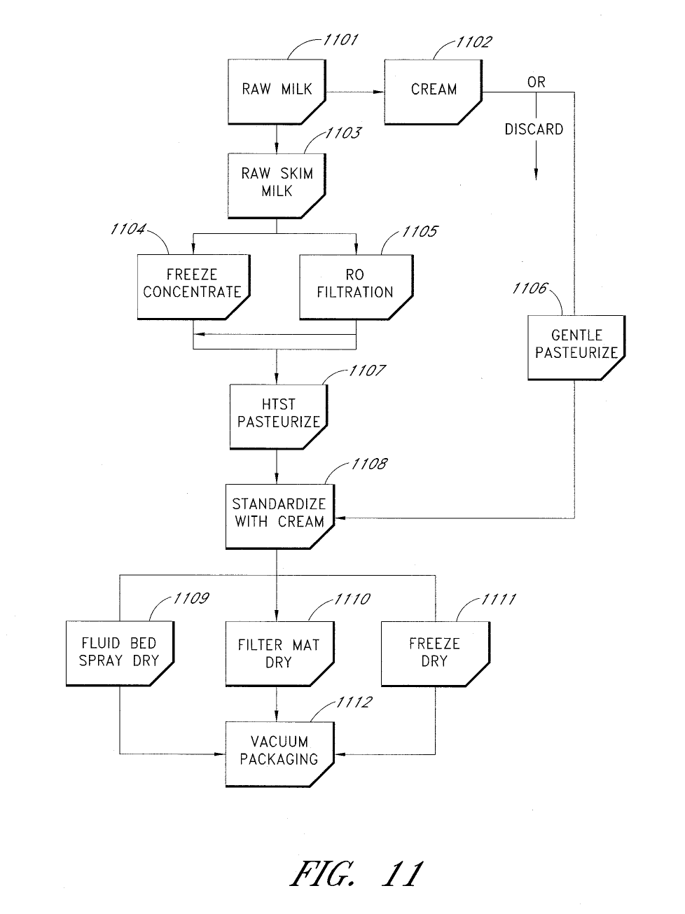

FIG. 11 shows an overview of one embodiment of preparing a shelf-stable dry dairy product. The methods for preparing a dry dairy component can, in some embodiments, differ from the methods for preparing a liquid dairy component in significant ways. For example, pasteurization is not used in the preparation of the liquid dairy component in the embodiment shown in FIG. 10. However, pasteurization is used in the preparation of a dry dairy component in the embodiment shown in FIG. 11. Referring to FIG. 11, a raw unpasteurized dairy component (such as raw milk) shown in block 1101 is separated into an aqueous subcomponent (such as raw skim milk) shown in block 1103 and a fat subcomponent (such as cream) shown in block 1102. The fat subcomponent can be discarded at this stage or undergo gentle pasteurization as shown in block 1106 and recombined with the aqueous subcomponent as shown in block 1108 after the aqueous subcomponent has undergone concentration, filtration and pasteurization. The aqueous subcomponent is concentrated using, for example, freeze concentration as shown in block 1104 and membrane filtration, such as reverse osmosis as shown in block 1105. The aqueous subcomponent can be optionally subjected to repeated rounds of filtration and concentration as shown by the arrow extending from block 1105 to 1104 to achieve the desired level of concentration. In some embodiments, more than one method of filtration and concentration is used. The concentrated aqueous subcomponent can then be sterilized, for example by pasteurization. In some embodiments, the pasteurization is at least one of gentle pasteurization or HTST pasteurization as shown in block 1107.

The aqueous subcomponent can be standardized as shown in block 1108 with at least one of protein, salts and a fat subcomponent such as cream. The fat subcomponent used to standardize the aqueous component may be the fat subcomponent shown in block 1102 or may be a fat subcomponent introduced from another source. In other embodiments, the aqueous subcomponent is standardized without a fat subcomponent but with protein and salts. In still another embodiment, the aqueous subcomponent standardized only with a fat subcomponent. The aqueous subcomponent can then be dried as shown in blocks 1109, 1110 and 1111 using at least one of freeze drying, spray drying, filter-mat drying, fluid bed drying, vacuum drying, drum drying, zeodration, etc. In some embodiments, gas can be bubbled into the aqueous subcomponent before and/or during the drying process. In some embodiments, the gas can be a mixture of gases. In some embodiments the gas can be one or more inert gases. In other embodiments, the gas can be air. After the dairy component is dried, it can be vacuum packaged as shown in block 1112. In some embodiments, the packaging is done in a manner which prevents contact with air, oxygen, bacteria, heat or any other substance which could damage or contaminate the dry dairy product. In some embodiments, aseptic packaging is utilized, for example, nitrogen purging, vacuum packaging, etc. Also, liquid nitrogen or any other oxygen scavenger can be used during packaging to minimize the degradative effects of oxygen.

In some embodiments, sugar can be added to the dairy-containing beverage such as, for example cane sugar, fructose, corn syrup, dextrose, malto-dextrose, maltodextrin, glycerine, threitol, erythritol, xylitol, arabitol, ribitol, sorbitol, mannitol, maltitol, maltotriitol, maltotetraitol, lactitol, hydrogenated isomaltulose, hydrogented starch, shellac, ethyl cellulose, hydroxy propyl methylcellulose, starches, modified starches, carboxyl cellulose, carrageenan, cellulose acetate phthalate, cellulose acetate trimellitate, chitosan, corn syrup solids, dextrins, fatty alcohols, hydroxy cellulose, hydroxy ethyl cellulose, hydroxy methyl cellulose, hydroxy propyl cellulose, hydroxy propyl ethyl cellulose, hydroxy propyl methyl cellulose, hydroxy propyl methyl cellulose phthalate, polyethylene glycol or a combination thereof.

Also, additional flavoring can be added to the dairy-containing beverage such as, for example, vanilla, chocolate, hazelnut, caramel, cinnamon, mint, eggnog, apple, apricot, aromatic bitters, banana, berry, blackberry, blueberry, celery, cherry, cranberry, strawberry, raspberry, juniper berry, brandy, cachaca, carrot, citrus, lemon, lime, orange, grapefruit, tangerine, coconut, cola, menthol, gin, ginger, licorice, hot, milk, nut, including almond, macadamia nut, peanut, pecan, pistachio, walnut, peach, pear, pepper, pineapple, plum, quinine, rum, white rum, dark rum, sangria, shellfish, clam, tea, black tea, green tea, tequila, tomato, top note, tropical, vermouth, dry vermouth, sweet vermouth, whiskey, bourbon whiskey, Irish whiskey, rye whiskey, Scotch whisky, Canadian whiskey, red pepper, black pepper, horseradish, wasabi, jalapeno pepper, chipotle pepper essential oils, concretes, absolutes, resins, resinoids, balms, tinctures, amyris oil, angelica seed oil, angelica root oil, aniseed oil, valerian oil, basil oil, tarragon oil, eucalyptus citriodora oil, eucalyptus oil, fennel oil, fir needle oil, galbanum oil, galbanum resin, geranium oil, grapefruit oil, guaiac wood oil, guaiac balsam, guaiac balsam oil, helichrysum absolute, helichrysum oil, ginger oil, iris root absolute, iris root oil, jasmin absolute, calmus oil, chamomile oil bleu, chamomile oil roman, carrot seed oil, cascarilla oil, pine needle oil, mint oil, carvi oil, labdanum oil, labdanum absolute, labdanum resin, lavandin absolute, lavandin oil, lavender absolute, lavender oil, lemongrass oil, Bursera penicillata (linaloe) oil, litsea-cubeba oil, bay laurel leaf oil, macis oil, marjoram oil, mandarin oil, massoirinde oil, mimosa absolute, ambrette seed oil, ambrette tincture, muskatelle salbei oil, nutmeg oil, orange blossom absolute, orange oil, oregano oil, palmarosa oil, patchouli oil, perilla oil, parsley leaf oil, parsley seed oil, clove seed oil, peppermint oil, pepper oil, pimento oil, pine oil, poley oil, rose absolute, rose wood oil, rose oil, rosemary oil, sage oil, lavandin, sage oil Spanish, sandalwood oil, celery seed oil, lavender spike oil, star anis oil, styrax oil, tagetes oil, pine needle oil, tea-tree oil, turpentine oil, thyme oil, tolu balm, tonka absolute, tuberose absolute, vanilla extract, violet leaf absolute, verbena oil, vetiver oil, juniper berry oil, wine yeast oil, wormwood oil, wintergreen oil, ylang ylang oil, hyssop oil, civet absolute, cinnamon leaf oil, cinnamon bark oil etc. or a combination thereof.

In some embodiments, coffee, dairy, carbohydrates, flavoring and other ingredients can be combined at a variety of stages of processing and in many different combinations. Some embodiments relate to co-drying of different components in preparation of a beverage. For example, pulverized coffee can be added to liquid coffee (extract or concentrate), liquid dairy (extract or concentrate) or liquid coffee/dairy (extract or concentrate) and then the resulting mixture can undergo sterilization and/or drying. In some embodiments, pulverized coffee, for example, can be added to a coffee/dairy beverage, a coffee/dairy/carbohydrate beverage, a coffee/dairy/carbohydrate/flavoring beverage, a coffee/carbohydrate beverage, or a coffee/flavoring beverage etc. before drying of the beverage. In some embodiments, pulverized coffee, for example, can be added to a coffee/dairy beverage, a coffee/dairy/carbohydrate beverage, a coffee/dairy/carbohydrate/flavoring beverage, a coffee/carbohydrate beverage, or a coffee/flavoring beverage etc. during the drying of the beverage. In some embodiments, pulverized coffee, for example, can be added to a coffee/dairy beverage, a coffee/dairy/carbohydrate beverage, a coffee/dairy/carbohydrate/flavoring beverage, a coffee/carbohydrate beverage, or a coffee/flavoring beverage etc. after the drying of the beverage. In some embodiments, pulverized coffee, for example, can be added to a coffee/dairy beverage, a coffee/dairy/carbohydrate beverage, a coffee/dairy/carbohydrate/flavoring beverage, a coffee/carbohydrate beverage, or a coffee/flavoring beverage etc. both before and after the drying of the beverage. In some embodiments, pulverized coffee, for example, can be added to a coffee/dairy beverage, a coffee/dairy/carbohydrate beverage, a coffee/dairy/carbohydrate/flavoring beverage, a coffee/carbohydrate beverage, or a coffee/flavoring beverage etc. before, after and during the drying of the beverage. In some embodiments, pulverized coffee, for example, can be added to a coffee/dairy beverage, a coffee/dairy/carbohydrate beverage, a coffee/dairy/carbohydrate/flavoring beverage, a coffee/carbohydrate beverage, or a coffee/flavoring beverage etc. before and during the drying of the beverage. In some embodiments, pulverized coffee, for example, can be added to a coffee/dairy beverage, a coffee/dairy/carbohydrate beverage, a coffee/dairy/carbohydrate/flavoring beverage, a coffee/carbohydrate beverage, or a coffee/flavoring beverage etc. during and after the drying of the beverage.

Some embodiments relate to dairy products combined with soluble or instant coffee. Coffee and other products subjected to processing such as that necessary to make an instant form of the product go through flavor and aroma changes. These changes come from the altering of the initial bonded structures of the compounds within the products. With coffee, any kind of processing can alter the bonded structures of the compounds found in unprocessed coffee beans. Some embodiments relate to a method of adding or restoring the flavor and aroma associated with an unprocessed food product to a processed or instant version of the product. In some embodiments, the product is coffee. Some embodiments relate to methods involving pulverization of, for example, roasted coffee beans, fresh tea leaves, coco beans or other food ingredients as a means of adding or restoring freshness, flavor and aroma of, for example, soluble coffee, teas, chocolates, etc. Some embodiments also allow for the introduction of different and unique flavors and aromas into food products. Some embodiments allow for the introduction of supplements to food products.

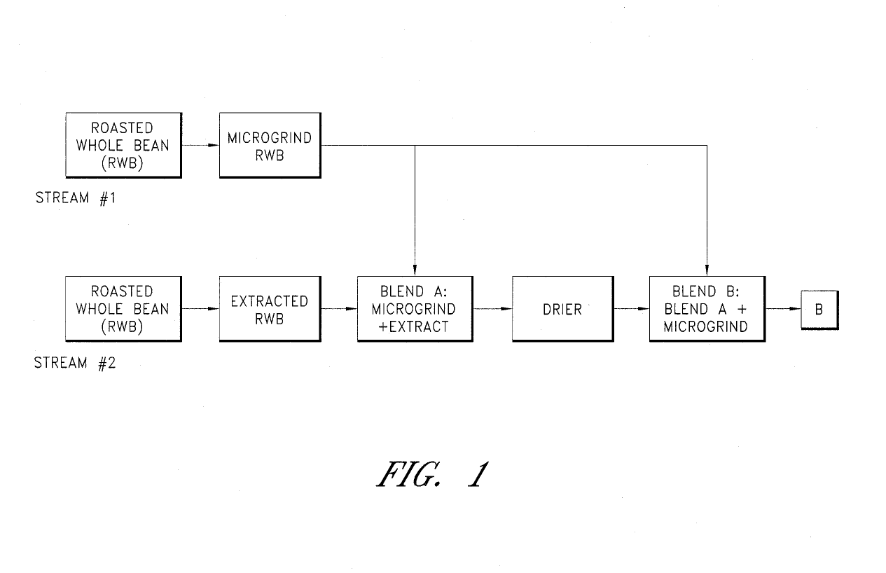

The above description regarding preparation of a dairy component discussed the addition of coffee to dairy and combinations including coffee, dairy and other ingredients. Since some embodiments of the present disclosure are directed to soluble coffee and methods of making soluble coffee with improved taste and aroma, the following disclosure gives additional details regarding the preparation of soluble coffee. Referring to FIG. 1, in accordance with an illustrative embodiment, two streams of roasted whole coffee beans are prepared and treated. In the first stream, roasted whole bean coffee beans are pulverized to form pulverized coffee. In some embodiments, the pulverized coffee has a particle size of less than about 350 microns in diameter. In some embodiments, the pulverized coffee component has a median particle size of about 350 microns or less. In the second stream, roasted whole bean coffee beans are ground or pulverized and extracted to produce a wet coffee extract. A portion of the pulverized coffee from the first stream is added to the wet coffee extract of the second stream to form blend A.

In the embodiments described in FIG. 1, the combination of pulverized roasted whole bean coffee beans from the first stream with the extracted ground or pulverized whole bean coffee of the second stream at this wet stage of the process adds complexity, including a more authentic coffee flavor and aroma, to the soluble coffee. Blend A is then dried in a drying process (e.g., at least one of freeze drying, spray drying, filter-mat drying, fluid bed drying, vacuum drying, drum drying, zeodration, etc). Dried blend A is then combined with at least one additional component to form blend B, which, in this embodiment, is the bulk soluble coffee product. Such components can include, for example, pulverized coffee from the first stream, coffee extract, concentrated coffee, dried coffee, coffee oils, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract and an herbal extract etc. In certain embodiments the dried blend A is combined with pulverized coffee from the first stream to form blend B.

In some embodiments, the dry addition of pulverized coffee to dry coffee extract adds aroma, flavor complexity and body to the finished bulk product. The addition of pulverized coffee can be accomplished by one or more of many different methods, e.g., centrifugal equipment, lightning mixer, ribbon blender, PK blender, sonic methods, etc. In some embodiments, other compounds may be added during the process, including non-coffee oils, non-coffee aromas, coffee aromas, etc. In some embodiments, pulverized coffee can be encapsulated with carbohydrates, soy products, dairy ingredients or other agents. One advantage of the encapsulation is to protect against degradation from environmental factors. In some embodiments, encapsulation can also alter the rate of solubility of the coffee components so that coffee aroma components and coffee flavor components are released from the pulverized or ground coffee at different times compared to other ingredients in the coffee product.

Coffee aromas are the volatile components of coffee that produce the characteristic fragrance of coffee. In some embodiments, the coffee aroma can be provided to the final beverage product in the form of a highly aromatized coffee concentrate. The aromatized coffee concentrate is prepared by adding coffee aroma to a coffee concentrate. Methods of preparing coffee concentrates are well known to one of skill in the art.

In some embodiments, coffee aroma is in the form of natural coffee aroma components that are collected during the preparation of soluble coffee powder. In some embodiments, the natural coffee aroma includes highly volatile aroma components. Highly volatile aroma components are those which condense at a temperature below about 0° C. To recover highly volatile aroma components, volatile aroma components may be flushed from the coffee during processing using an inert carrier gas such as nitrogen, carbon dioxide gas or carbon dioxide pellets, for example. The aroma-laden carrier gas is then chilled to temperatures lower than about −40° C., and sometimes as low as about −195° C., to cause the aroma components to condense. The condensed aroma components are then collected. Suitable procedures for capturing coffee aroma are known to one of skill in the art.

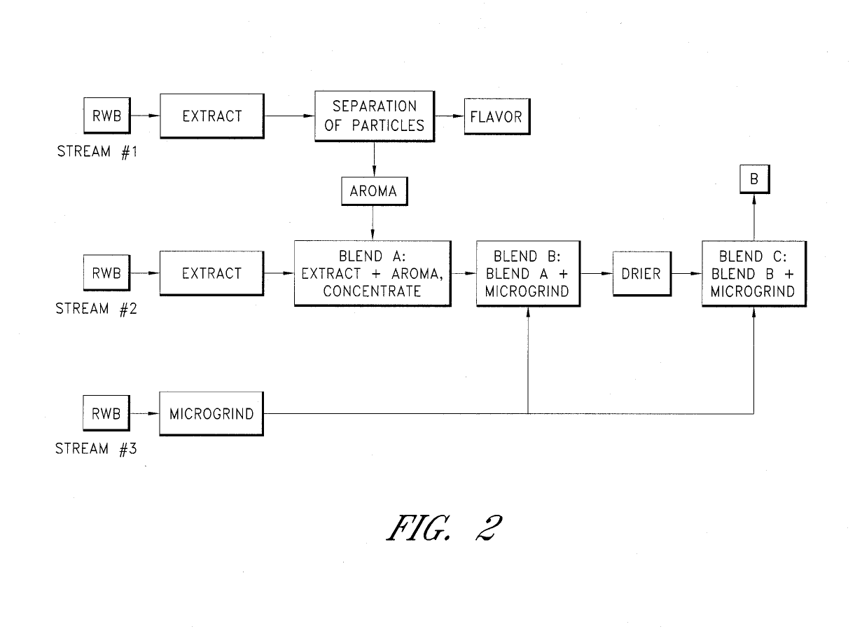

Referring to FIG. 2, in accordance with an illustrative embodiment, three streams of roasted whole coffee beans are treated to form a coffee product with enhanced flavor and aroma components. In the first stream, roasted whole bean coffee beans are pulverized or ground to form pulverized or ground coffee. In some embodiments, the pulverized or ground coffee has a particle size of less than about 350 microns in diameter. In some embodiments, the pulverized coffee component has a median particle size of about 350 microns or less in diameter. The pulverized or ground coffee is then extracted to separate the aroma compounds from the flavor compounds. In the second stream, roasted whole bean coffee beans are pulverized or ground and extracted to produce a wet coffee extract. A portion of the separated aroma components from the first stream is added to the wet coffee extract of the second stream to form blend A. In the third stream, roasted whole bean coffee beans are pulverized and a portion of the resulting pulverized coffee is added to wet blend A to form blend B.

Blend B is then dried in a drying process (e.g., at least one of freeze drying, spray drying, filter-mat drying, fluid bed drying, vacuum drying, drum drying, zeodration, etc). Dried blend B is then combined with at least one of: pulverized coffee from the third stream, coffee extract, concentrated coffee, dried coffee, coffee oils, coffee aromas (distillates), flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract and an herbal extract to form blend C, which, in this embodiment, is the bulk soluble coffee product. In certain embodiments the dried blend B is combined with pulverized coffee from the third stream to form blend C. In some embodiments, the flavor components of the extracted pulverized or ground coffee of the first stream are combined with blend A. In some embodiments, the flavor components of the extracted pulverized or ground coffee of the first stream are combined with blend B. In some embodiments, the flavor components of the extracted pulverized or ground coffee of the first stream are combined with blend C.

In some embodiments, the combination of the pulverized or ground roasted whole bean coffee aroma separation components from the first stream with the extracted pulverized or ground whole bean coffee of the second stream at this wet stage of the process adds a unique aroma property, including a more authentic coffee aroma, to the soluble coffee.

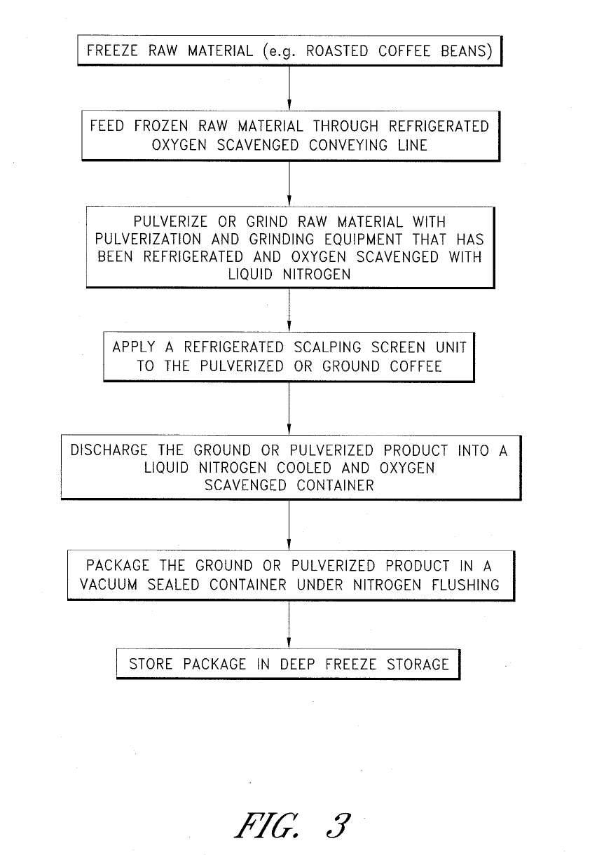

FIG. 3 depicts an illustrative process for preparing some of the products of certain embodiments. In this example, roasted coffee beans are frozen at a temperature below about −5° C. and then fed through a conveying line that is also refrigerated. Then the product is pulverized in the presence of liquid nitrogen and/or carbon dioxide and sent through a scalping screen to ensure the passage of only small particle pulverization product. In some embodiments, liquid nitrogen and/or carbon dioxide is added directly to the product. In some embodiments, the liquid nitrogen and/or carbon dioxide is used to cool the grinding or pulverizing machinery. In some embodiments the liquid nitrogen and/or carbon dioxide is added directly to the product and also used to cool the grinding or pulverizing machinery. In an illustrative embodiment, the ground product is then discharged into packaging, vacuum sealed, flushed with nitrogen and then stored in deep freeze storage. However, in some embodiments, the ground product is instead introduced into other process steps as those discussed herein. In some embodiments, the packaged and stored product can be later used in other processes as well.

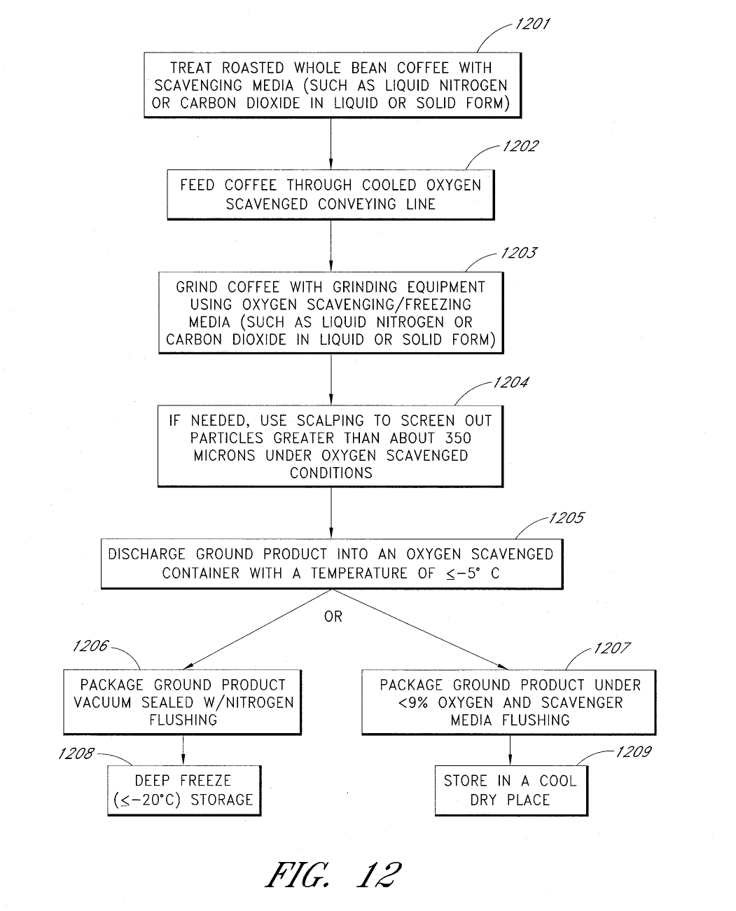

FIG. 12 shows another overview of an example method of pulverizing a raw material in a refrigerated environment. In this embodiment, roasted whole bean coffee is treated with oxygen scavenging media such as liquid nitrogen or carbon dioxide in liquid or solid (e.g. pellet) form as shown in block 1201. Then the treated coffee is fed through a cooled conveying line that also contains oxygen scavenging media as shown in block 1202. The treated coffee can then be ground with grinding equipment that contains oxygen scavenging or freezing media such as liquid nitrogen or carbon dioxide in liquid or solid (e.g. pellet) form as shown in block 1203. Optionally, scalping can be performed on the ground coffee under oxygen scavenging conditions to screen out particles greater than about 350 microns as shown in block 1204. Then the ground coffee product is discharged into a container that has been treated with oxygen scavenging media at a temperature of less than or equal to −5° C. as shown in block 1205. In one embodiment, the ground coffee product can then be packaged with vacuum sealing and nitrogen flushing as shown in block 1206 and then stored in a deep freeze (less than or equal to −20° C.) as shown in block 1208. In another embodiment, the ground coffee product can be packaged under less than 9% oxygen with oxygen scavenger media flushing as shown in block 1207 and then stored in a cool dry place as shown in block 1209.

In some embodiments, a third pulverized coffee product is blended with the first dried coffee blend to form the soluble coffee product. In one example, four blends of coffees are used. One of the four roasted and pulverized coffee components is added to an extract or concentrate obtained from the four base blend. The resulting product can then be dried and fortified and then blended with a pulverized coffee component from a second or third or fourth roasted whole bean coffee component to produce the coffee product.

In some embodiments, the pulverized or ground coffee can be produced in concert with refrigeration of the grinding machinery. Also, in some embodiments, ground or pulverized coffee product can be cooled as it leaves the grinding machinery. In some embodiments the grinding machinery is refrigerated and also the pulverized or ground coffee product is cooled as it exits the grinding machinery.

In accordance with some embodiments, coffee can be processed as described above to maintain a pleasing flavor and aroma. In some embodiments, roasted whole bean coffee is processed under low temperatures, for example, less than about 15° C. and low relative humidity, for example, less than about 30%. In some embodiments, the internal temperature of the milling equipment is controlled to ensure a temperature of less than about 15° C. Roasted whole bean coffee beans can be pre-frozen and surfaces that come into contact with the coffee beans can be kept cooled with a cooling medium, such as, for example, liquid nitrogen and/or carbon dioxide, to avoid flavor loss and degradation.

Coffee exposure to oxygen can be minimized using conventional methods, for example, nitrogen purging, vacuum packaging, etc. Also, liquid nitrogen can be used as an oxygen scavenger during processing to minimize the degradative effects of oxygen. Coffee that is pulverized under such conditions retains much of its original flavor and aroma. Such pulverized coffee can be blended or encapsulated with coffee in various forms, including ground coffee, extracts, concentrate coffee, dried coffee, coffee oils, aromas (distillates), carbohydrates, soy products, dairy products or other agents and subsequently added to dry soluble coffee.

In some embodiments, coffee and other products being subjected to pulverization are deep frozen (colder than −5° C.) prior to grinding. This process allows for better pulverization of the product and yields more homogenous particles while minimizing the oxidation and degradation of the pulverized product. Lines supplying the grinder can be equipped with, for example, refrigerants or a liquid nitrogen and/or carbon dioxide feeding system in order to maintain the low temperature and efficiency. Cooling and scavenging gases are ideal, since they can provide cooling and removal of oxidizing elements. To minimize condensation, the equipment can be insulated to avoid surface and internal condensations in the conveying equipment pulverizing equipment and collection/storage equipment of the milled product.

Any type of grinding equipment can be used in the present embodiments, for example, a cage mill, a hammer mill, a single-stage roller grinder, a multistage roller grinder, etc. to pulverize a product such as coffee. In some embodiments, the equipment is maintained at very low temperatures (−50° C. to 20° C.) via cooling media. This helps maintain the integrity of the material being pulverized. Liquid nitrogen and/or carbon dioxide or other refrigerants can be used to cool the equipment. Pulverization generates heat, which combined with exposed oxygen, can often degrade the pulverized product. Feeding liquid nitrogen and/or carbon dioxide to the grinding cavity is one example of a way to keep the grinding machine at low temperatures as well as displacing and scavenging oxygen.

In some embodiments the pulverized product falls into a refrigerated container at from about 0° C. to about 20° C. In some embodiments the pulverized product falls into a refrigerated container at less than about 20° C. Some embodiments involve using liquid nitrogen and/or carbon dioxide cooling of the container including liquid or gas nitrogen inside the container for product preservation. Other embodiments involve liquid or gas carbon dioxide, CO₂ pellets, liquid or gas argon, air or other inert gases. During operation, the discharging cavity should be continually flushed with gaseous nitrogen to minimize oxidation. In some embodiments, the operation takes place under controlled environmental conditions to protect the resulting product from moisture uptake.

In some embodiments, in order to ensure quality, the final product is moved to an oxygen free environment, vacuum packed, sealed and stored under deep freeze conditions (about −20° C. or colder), until used or sold.

Some embodiments relate to blending pulverized components in with liquid (wet blending) and dry (dry blending) coffee ingredients and/or related products. The dry or wet blending operation is the process of incorporating, adding, infusing, mixing, encapsulating, spraying or fluidizing, etc, the pulverized product into a coffee or appropriate product stream at required ratio to deliver design aroma, flavor, and appearance. Adequate processing (ribbon blender, PK blenders, fluidizing beds, coaters, rotary wheel blenders or others) and mixing equipments can be used to ensure homogeneity. In some embodiments the wet blending takes place at controlled temperatures, e.g., less than about 15° C. Rotation, cycle time and control of the process can differ, however, in some embodiments, these variables are controlled in such a way as to ensure uniform distribution, and prevent foaming and particle segregation.

In some embodiments, dry blending occurs in an enclosed blender and a controlled environment to minimize oxidation and moisture exposure. Upon blending, the product can be readily stored in proper packaging, such as, for example packed tightly to form a brick like package with nitrogen flushing and maintained under controlled conditions, such as temperatures less than about 10° C.

In some embodiments, the physicochemical and sensory attributes of pulverized products can also be protected by means of encapsulation (e.g. spray-drying, coating, extrusion, coacervation and molecular inclusion). Some embodiments utilize microencapsulation. With encapsulation, an encasing layer is attained, for example, via molecular, interfacial, colloidal and bulk physicochemical properties of emulsions. The encasement reduces the reactivity of the core with regard to outside environment, for example oxygen and water. This permits the extension of shelf life of a product in conventional packaging applications. In some embodiments, encapsulation can be used for controlled release of the inner material or core. The encased pulverized product can remain inactive until direct contact with water. Then the water can dissolve the encasement and the pulverized product is able to react with water, releasing aromas and flavors.

In some embodiments, the encapsulation of pulverized coffee can be used to optimize product functionality, particle size and/or create a new product form. Encapsulation can be done with one or more products including, for example, coffee, coffee extracts, coffee concentrates, dry pulverized coffee, coffee oils or other oils, aromas, functional ingredients, etc. In addition, encapsulation can also done with one or more of carbohydrates, soy products, dairy products, corn syrup, hydrocolloids, polymers, waxes, fats, vegetable oils, gum arabic, maltodextrin, glycerine, threitol, erythritol, xylitol, arabitol, ribitol, sorbitol, mannitol, maltitol, maltotriitol, maltotetraitol, lactitol, hydrogenated isomaltulose, hydrogented starch, liposomes, liposomes in sol-gels, shellac, hydrolyzed fats, ethyl cellulose, hydroxy propyl methylcellulose, starches, modified starches, alginate and alginic acid (e.g., sodium alginate), calcium caseinate, calcium polypectate, carboxyl cellulose, carrageenan, cellulose acetate phthalate, cellulose acetate trimellitate, chitosan, corn syrup solids, dextrins, fatty acids, fatty alcohols, gelatin, gellan gums, hydroxy cellulose, hydroxy ethyl cellulose, hydroxy methyl cellulose, hydroxy propyl cellulose, hydroxy propyl ethyl cellulose, hydroxy propyl methyl cellulose, hydroxy propyl methyl cellulose phthalate, lipids, liposomes, low density polyethylene, mono-, di- and tri-glycerides, pectins, phospholipids, polyethylene glycol, polylactic polymers, polylactic co-glycolic polymers, polyvinyl pyrrolindone, stearic acid and derivatives, xanthum and proteins, zein, gluten or other agents to protect against environmental elements.

In some embodiments, components of a beverage such as coffee, dairy, carbohydrate, flavoring or any combination thereof can be flocculated. In some embodiments, the flocculation can be done prior to drying with such methods as freeze drying, spray drying, filter-mat drying, fluid bed drying, vacuum drying, drum drying, zeodration, etc. The flocculation process can be done with gas. In some embodiments, the gas can be a mixture of gases. In some embodiment, the gas can be one or more inert gases. In some embodiments the gas can be air. Some embodiments relate to the use of such inert gases as CO₂, or N₂ which scavenge oxygen, improve shelf life and form foam upon reconstitution of the finished product with water. The flocculation process can also be used to incorporate, for example, pulverized coffee, dairy (liquid or dry), carbohydrates, flavoring, etc to form enhanced coffee or blended coffee and milk.

In some embodiments, flocculation allows for insertion into a dairy component of at least one of a coffee concentrate (liquid or dry), carbohydrates, and flavoring to form a blended product. In some embodiments, flocculation allows for insertion into a coffee component of at least one of a dairy component, carbohydrates, and flavoring to form a blended product. In some embodiments, flocculation allows for insertion into a carbohydrate component of at least one of a coffee concentrate (liquid or dry), a dairy component, and flavoring to form a blended product. In some embodiments, flocculation allows for insertion into a flavoring component of at least one of a coffee concentrate (liquid or dry), carbohydrates, and a dairy component to form a blended product. In addition, during flocculation, it is possible to incorporate at least one of a coffee extract, concentrated coffee, dried coffee, soluble coffee, coffee oils, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, a dry green coffee extract, a wet green coffee extract, pulverized coffee, ground coffee and an herbal extract, for example.

The following examples are provided for illustrative purposes only, and are in no way intended to limit the scope of the present embodiments.

### Example 1

Coffee was roasted, extracted and concentrated, and then passed through a flocculator prior to freeze drying. A cold surface scraping mechanism was used which inserts air into the roasted, extracted and concentrated coffee. Air becomes entrapped in the coffee which can improve superficial tension for sublimation processes. Air incorporation into the media facilitates pure crystal formation upon freezing. Air molecules form voids that mobilize water molecules to aggregate that in turn aid the sublimation process. Since water has been gathered to form ice crystals, the coffee molecules are also segregated. During sublimation, voids formed by air allow for selective sublimation of water leaving the coffee and its volatiles behind.

### Example 2

A dairy component was flocculated as described below. A liquid dairy component was passed through a flocculator prior to freeze drying. A cold surface scraping mechanism was used which inserts air into the dairy component. Air becomes entrapped in the dairy component which can improve superficial tension for sublimation processes. Air incorporation into the media facilitates pure crystal formation upon freezing. Air molecules form voids that mobilize water molecules to aggregate that in turn aid the sublimation process. Once the crema was frozen into a thin sheet, it was granulated. Bigger granules go through the process and fines return to the extract. Some embodiments relate to a shelf-stable dairy product comprising an aseptic liquid dairy component comprising an aqueous subcomponent, wherein the aqueous subcomponent has been separated from a fat subcomponent, wherein the aqueous subcomponent has undergone filtration, concentration and sterilization, and wherein the aqueous subcomponent has not been pasteurized.

The present disclosure is not limited in any way by specific examples discussed herein, but covers a wide variety of alterations and equivalents. Some examples of embodiments covered follow. Some embodiments relate to a shelf-stable dairy product comprising an aseptic liquid dairy component comprising an aqueous subcomponent, wherein the aqueous subcomponent has been separated from a fat subcomponent, wherein the aqueous subcomponent has undergone filtration, concentration and sterilization, and wherein the aqueous subcomponent has not been pasteurized. In some embodiments, at least a portion of the fat subcomponent has been recombined with the aqueous subcomponent after the aqueous subcomponent has been concentrated and before the aqueous subcomponent has been sterilized.

In some embodiments, at least a portion of the fat subcomponent has been discarded after separation from the aqueous subcomponent.

In some embodiments, the concentration comprises at least one of membrane filtration and freeze concentration.

In some embodiments, the sterilization comprises high pressure sterilization.

In some embodiments, the filtration comprises membrane filtration.

In some embodiments, aseptic liquid dairy component, the aqueous subcomponent and the fat subcomponent have not been heated above about 140° F.

In some embodiments, aseptic liquid dairy component, the aqueous subcomponent and the fat subcomponent have not been heated above about 135° F.

In some embodiments, aseptic liquid dairy component, the aqueous subcomponent and the fat subcomponent have not been heated above about 130° F.

In some embodiments, aseptic liquid dairy component, the aqueous subcomponent and the fat subcomponent have not been heated above about 120° F.

In some embodiments, the membrane filtration comprises at least one of nanofiltration, microfiltration, reverse osmosis and ultrafiltration.

In some embodiments, the high pressure sterilization comprises temperature assisted pressure sterilization.

In some embodiments, the membrane filtration comprises at least one of nanofiltration, microfiltration, reverse osmosis and ultrafiltration.

In some embodiments, neither the aqueous subcomponent nor the fat subcomponent contain artificial stabilizers or additives.

In some embodiments, the aqueous subcomponent and the fat subcomponent contain less than about 1 colony forming unit of spore forming bacteria per 1000 kg of the aseptic liquid dairy component.

Some embodiments further comprise a coffee component.

In some embodiments, the coffee component is a soluble coffee component.

Some embodiments relate to a method of making a shelf-stable dairy product, the method comprising separating a raw unpasteurized liquid dairy component into an aqueous subcomponent and a fat subcomponent; filtering the aqueous subcomponent; concentrating the aqueous subcomponent; and sterilizing the aqueous subcomponent, wherein the raw unpasteurized liquid dairy component, the aqueous subcomponent and the fat subcomponent are not pasteurized, and wherein the shelf-stable dairy product comprises the filtered, concentrated and sterilized aqueous subcomponent.

Some embodiments further comprise adding at least a portion of the fat subcomponent to the aqueous subcomponent before sterilizing the aqueous subcomponent, wherein the shelf-stable dairy product comprises the filtered, concentrated and sterilized aqueous subcomponent combined with at least a portion of the fat subcomponent, and wherein neither the aqueous subcomponent nor the fat subcomponent have been heated to a temperature above about 140° F.

In some embodiments, the raw unpasteurized liquid dairy component comprises raw unpasteurized milk.

In some embodiments, filtering the aqueous subcomponent comprises membrane filtration.

In some embodiments, the membrane filtration comprises at least one of nanofiltration, microfiltration, reverse osmosis and ultrafiltration.

In some embodiments, concentrating the aqueous subcomponent comprises at least one of reverse osmosis, microfiltration and ultrafiltration.

In some embodiments, sterilizing the aqueous subcomponent comprises high pressure sterilization.

In some embodiments, the high pressure sterilization comprises temperature assisted pressure sterilization.

In some embodiments, the temperature assisted pressure sterilization is carried out at a temperature of from about 60° F. to about 140° F., a pressure of from about 3000 bar to about 9000 bar and for a time from about 30 seconds to about 10 minutes.

In some embodiments, the raw unpasteurized liquid dairy component, the aqueous subcomponent and the fat subcomponent are not heated to a temperature above about 140° F.

In some embodiments, the raw unpasteurized liquid dairy component, the aqueous subcomponent and the fat subcomponent are not heated to a temperature above about 135° F.

In some embodiments, the raw unpasteurized liquid dairy component, the aqueous subcomponent and the fat subcomponent are not heated to a temperature above about 130° F.

In some embodiments, the raw unpasteurized liquid dairy component, the aqueous subcomponent and the fat subcomponent are not heated to a temperature above about 120° F.

Some embodiments further comprise adding at least one carbohydrate to at least one of the raw unpasteurized liquid dairy component, the aqueous subcomponent and the fat subcomponent.

Some embodiments further comprise adding flavoring to at least one of the raw unpasteurized liquid dairy component, the aqueous subcomponent and the fat subcomponent.

Some embodiments further comprise adding to at least one of the raw unpasteurized liquid dairy component, the aqueous subcomponent and the fat subcomponent, at least one of a coffee extract, concentrated coffee, dried coffee, soluble coffee, coffee oils, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, a dry green coffee extract, a wet green coffee extract, pulverized coffee, ground coffee and an herbal extract.

Some embodiments relate to a shelf-stable beverage comprising a dairy product prepared by the method comprising separating a raw unpasteurized liquid dairy component into an aqueous subcomponent and a fat subcomponent; filtering the aqueous subcomponent; concentrating the aqueous subcomponent; and sterilizing the aqueous subcomponent, wherein the raw unpasteurized liquid dairy component, the aqueous subcomponent and the fat subcomponent are not pasteurized, and wherein the shelf-stable dairy product comprises the filtered, concentrated and sterilized aqueous subcomponent.

Some embodiments further comprise adding at least a portion of the fat subcomponent to the aqueous subcomponent before sterilizing the aqueous subcomponent, wherein the shelf-stable dairy product comprises the filtered, concentrated and sterilized aqueous subcomponent combined with at least a portion of the fat subcomponent, and wherein neither the aqueous subcomponent nor the fat subcomponent have been heated to a temperature above about 140° F.

In some embodiments, the raw unpasteurized liquid dairy component comprises raw unpasteurized milk.

In some embodiments, filtering the aqueous subcomponent comprises membrane filtration.

In some embodiments, the membrane filtration comprises at least one of nanofiltration, microfiltration, reverse osmosis and ultrafiltration.

In some embodiments, concentrating the aqueous subcomponent comprises at least one of microfiltration, reverse osmosis and ultrafiltration.

In some embodiments, sterilizing the aqueous subcomponent comprises high pressure sterilization.

In some embodiments, the high pressure sterilization comprises temperature assisted pressure sterilization.

In some embodiments, the temperature assisted pressure sterilization is carried out at a temperature of from about 60° F. to about 140° F., a pressure of from about 3000 bar to about 9000 bar and for a time from about 30 seconds to about 10 minutes.

In some embodiments, the raw unpasteurized liquid dairy component, the aqueous subcomponent and the fat subcomponent are not heated to a temperature above about 140° F.

In some embodiments, the raw unpasteurized liquid dairy component, the aqueous subcomponent and the fat subcomponent are not heated to a temperature above about 135° F.

In some embodiments, the raw unpasteurized liquid dairy component, the aqueous subcomponent and the fat subcomponent are not heated to a temperature above about 130° F.

In some embodiments, the raw unpasteurized liquid dairy component, the aqueous subcomponent and the fat subcomponent are not heated to a temperature above about 120° F.

Some embodiments further comprise adding sugar to at least one of the raw unpasteurized liquid dairy component, the aqueous subcomponent and the fat subcomponent.

Some embodiments further comprise adding flavoring to at least one of the raw unpasteurized liquid dairy component, the aqueous subcomponent and the fat subcomponent.

Some embodiments further comprise adding to at least one of the raw unpasteurized liquid dairy component, the aqueous subcomponent and the fat subcomponent, at least one of a coffee extract, concentrated coffee, dried coffee, soluble coffee, coffee oils, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, a dry green coffee extract, a wet green coffee extract, pulverized coffee, ground coffee and an herbal extract.

Some embodiments relate to a system for preparing a shelf-stable dairy product comprising a component for separating a raw unpasteurized dairy substance into an aqueous substance and a fat substance; a component for concentrating the aqueous substance; a component for filtering the aqueous substance; and a component for sterilizing the aqueous substance, wherein the raw unpasteurized dairy substance, the aqueous substance and the fat substance are not heated to a temperature above about 140° F.

Some embodiments further comprise a component for adding coffee to the aqueous substance.

In some embodiments, the coffee comprises a soluble coffee.

Some embodiments further comprise a component for adding at least a portion of the separated fat substance to the aqueous substance.

Some embodiments relate to a shelf-stable dairy product comprising an aseptic dairy component comprising an aqueous subcomponent, wherein the aqueous subcomponent has been separated from a fat subcomponent; wherein the aqueous subcomponent has undergone concentration, sterilization and drying, and wherein the aqueous subcomponent has not been heated above about 80° F. more than one time during processing.

In some embodiments, at least a portion of the fat subcomponent has been recombined with the aqueous subcomponent after the aqueous subcomponent has been concentrated and before the aqueous subcomponent has been dried.

In some embodiments, at least a portion of the fat subcomponent has been discarded after separation from the aqueous subcomponent.

In some embodiments, the concentration comprises at least one of membrane filtration and freeze concentration.

In some embodiments, the sterilization comprises pasteurization.

In some embodiments, the drying comprises at least one of freeze drying, filter mat drying, fluid bed drying, spray drying, thermal evaporation and zeodration.

In some embodiments, the membrane filtration comprises reverse osmosis filtration.

In some embodiments, the pasteurization comprises HTST (high temperature short time) pasteurization.

In some embodiments, the drying comprises freeze drying.

In some embodiments, neither the aqueous subcomponent nor the fat subcomponent have been heated above about 70° F. more than one time.

In some embodiments, neither the aqueous subcomponent nor the fat subcomponent have been heated above about 60° F. more than one time.

In some embodiments, neither the aqueous subcomponent nor the fat subcomponent have been heated above about 50° F. more than one time.

In some embodiments, neither the aqueous subcomponent nor the fat subcomponent contain artificial stabilizers or additives.

In some embodiments, the aqueous subcomponent and the fat subcomponent contain less than about 1 colony forming unit of spore forming bacteria per 1000 kg of the aseptic dairy component.

Some embodiments further comprise a coffee component.

In some embodiments, the coffee component comprises a soluble coffee component.

Some embodiments relate to a method of making a shelf-stable dairy product, the method comprising separating a raw unpasteurized dairy component into an aqueous subcomponent and a fat subcomponent; concentrating the aqueous dairy component; sterilizing the aqueous dairy component; and drying the aqueous dairy component, wherein the raw unpasteurized dairy component, the aqueous subcomponent and the fat subcomponent are not heated to a temperature above about 80° F. more than one time during the method, and wherein the shelf-stable dairy product comprises the concentrated, sterilized and dried aqueous subcomponent.

Some embodiments further comprise adding at least a portion of the fat subcomponent to the aqueous subcomponent before drying the aqueous subcomponent, wherein the shelf-stable dairy product comprises the filtered, concentrated and dried aqueous subcomponent combined with at least a portion of the fat subcomponent, wherein neither the aqueous subcomponent nor the fat subcomponent have been heated to a temperature above about 80° F. more than one time.

In some embodiments, the raw unpasteurized dairy component comprises raw milk.

In some embodiments, concentrating the aqueous dairy component comprises at least one of membrane filtration and freeze concentration.

In some embodiments, sterilizing the aqueous dairy component comprises pasteurization.

In some embodiments, drying the aqueous dairy component comprises at least one of freeze drying, filter mat drying, fluid bed drying, spray drying, thermal evaporation and zeodration.

In some embodiments, the membrane filtration comprises reverse osmosis filtration.

In some embodiments, the pasteurization comprises HTST pasteurization.

In some embodiments, the drying comprises freeze drying.

In some embodiments, neither the aqueous subcomponent nor the fat subcomponent are heated above about 70° F. more than one time.

In some embodiments, neither the aqueous subcomponent nor the fat subcomponent are heated above about 60° F. more than one time.

In some embodiments, neither the aqueous subcomponent nor the fat subcomponent are heated above about 50° F. more than one time.

Some embodiments further comprise adding sugar to at least one of the raw unpasteurized liquid dairy component, the aqueous subcomponent and the fat subcomponent.

Some embodiments further comprise adding flavoring to at least one of the raw unpasteurized liquid dairy component, the aqueous subcomponent and the fat subcomponent.

Some embodiments further comprise adding to at least one of the raw unpasteurized liquid dairy component, the aqueous subcomponent and the fat subcomponent at any point in the method, at least one of a coffee extract, concentrated coffee, dried coffee, coffee oils, soluble coffee, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, a dry green coffee extract, a wet green coffee extract, pulverized coffee, roast coffee, roast and ground coffee, soluble coffee including pulverized coffee and an herbal extract.

Some embodiments relate to a shelf-stable beverage comprising a dairy product prepared by the method comprising: separating a raw unpasteurized liquid dairy component into an aqueous subcomponent and a fat subcomponent; concentrating the aqueous dairy component; sterilizing the aqueous dairy component; and drying the aqueous dairy component, wherein the raw unpasteurized dairy component, the aqueous subcomponent and the fat subcomponent are not heated to a temperature above about 80° F. more than one time during the method, and wherein the shelf-stable dairy product comprises the concentrated, sterilized and dried aqueous subcomponent.

Some embodiments further comprise adding at least a portion of the fat subcomponent to the aqueous subcomponent before drying the aqueous subcomponent; wherein the shelf-stable dairy product comprises the filtered, concentrated and dried aqueous subcomponent combined with at least a portion of the fat subcomponent, wherein neither the aqueous subcomponent nor the fat subcomponent have been heated to a temperature above about 80° F. more than one time.

In some embodiments, the raw unpasteurized dairy component comprises raw milk.

In some embodiments, concentrating the aqueous dairy component comprises at least one of membrane filtration and freeze concentration.

In some embodiments, sterilizing the aqueous dairy component comprises pasteurization.

In some embodiments, drying the aqueous dairy component comprises at least one of freeze drying, filter mat drying, fluid bed drying, spray drying, thermal evaporation and zeodration.

In some embodiments, the membrane filtration comprises reverse osmosis filtration.

In some embodiments, the pasteurization comprises HTST pasteurization.

In some embodiments, the drying comprises freeze drying.

In some embodiments, neither the aqueous subcomponent nor the fat subcomponent is heated above about 70° F. more than one time.

In some embodiments, neither the aqueous subcomponent nor the fat subcomponent is heated above about 60° F. more than one time.

In some embodiments, neither the aqueous subcomponent nor the fat subcomponent is heated above about 50° F. more than one time.

Some embodiments further comprise adding sugar to at least one of the raw unpasteurized liquid dairy component, the aqueous subcomponent and the fat subcomponent.

Some embodiments further comprise adding flavoring to at least one of the raw unpasteurized liquid dairy component, the aqueous subcomponent and the fat subcomponent.

Some embodiments further comprise adding to at least one of the raw unpasteurized liquid dairy component, the aqueous subcomponent and the fat subcomponent at any point in the method, at least one of a coffee extract, concentrated coffee, dried coffee, coffee oils, soluble coffee, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, a dry green coffee extract, a wet green coffee extract, pulverized coffee, roast coffee, roast and ground coffee, soluble coffee including pulverized coffee and an herbal extract.

Some embodiments relate to a system for preparing a shelf-stable dairy product comprising a component for separating a raw unpasteurized dairy substance into an aqueous substance and a fat substance; a component for concentrating the aqueous substance; a component for filtering the aqueous substance; a component for sterilizing the aqueous substance; and a component for drying the aqueous substance; wherein the raw unpasteurized dairy substance, the aqueous substance and the fat substance are not heated to a temperature above about 80° F. more than one time.

Some embodiments further comprise a component for adding coffee to the aqueous substance

In some embodiments, the coffee comprises a soluble coffee.

Some embodiments relate to a shelf-stable beverage comprising an aseptic liquid dairy component; and a soluble coffee component, wherein the aseptic liquid dairy component has undergone filtration, concentration and sterilization, and wherein the aseptic liquid dairy component has not been pasteurized.

In some embodiments, the soluble coffee component comprises a dry coffee extract component; and a pulverized coffee component, wherein the pulverized coffee component has not been extracted, and wherein the pulverized coffee component is added to the dry coffee extract component after the dry coffee extract is dried.

In some embodiments, the aseptic liquid dairy component comprises an aqueous subcomponent and a fat subcomponent, wherein the aqueous subcomponent has been separated from a fat subcomponent before the aqueous subcomponent has undergone filtration and concentration.

In some embodiments, at least a portion of the fat subcomponent has been recombined with the aqueous subcomponent after the aqueous subcomponent has been filtered and concentrated and before the aqueous subcomponent has been sterilized.

In some embodiments, at least a portion of the fat subcomponent has been discarded after separation from the aqueous subcomponent.

In some embodiments, the concentration comprises at least one of membrane filtration and freeze concentration.

In some embodiments, the sterilization comprises high pressure sterilization.

In some embodiments, the filtration comprises membrane filtration.

In some embodiments, the aseptic liquid dairy component, the aqueous subcomponent and the fat subcomponent have not been heated above about 140° F.

In some embodiments, the aseptic liquid dairy component, the aqueous subcomponent and the fat subcomponent have not been heated above about 135° F.

In some embodiments, the aseptic liquid dairy component, the aqueous subcomponent and the fat subcomponent have not been heated above about 130° F.

In some embodiments, the aseptic liquid dairy component, the aqueous subcomponent and the fat subcomponent have not been heated above about 120° F.

In some embodiments, the membrane filtration comprises at least one of microfiltration, reverse osmosis, nanofiltration and ultrafiltration.

In some embodiments, the high pressure sterilization comprises temperature assisted pressure sterilization.

In some embodiments, the membrane filtration comprises at least one of microfiltration, reverse osmosis, nanofiltration and ultrafiltration.

In some embodiments, the aseptic liquid dairy component, the aqueous subcomponent and the fat subcomponent do not contain artificial stabilizers or additives.

In some embodiments, the aseptic liquid dairy component, the aqueous subcomponent and the fat subcomponent contain less than about 1 colony forming unit of spore forming bacteria per 1000 kg of the aseptic liquid dairy component.

Some embodiments relate to a method of making a shelf-stable beverage, the method comprising separating a raw unpasteurized liquid dairy component into an aqueous subcomponent and a fat subcomponent; filtering the aqueous subcomponent; concentrating the aqueous subcomponent; sterilizing the aqueous subcomponent; and adding the aqueous subcomponent to a soluble coffee component, wherein the raw unpasteurized liquid dairy component, the aqueous subcomponent and the fat subcomponent are not pasteurized, and wherein the shelf-stable beverage comprises the soluble coffee component and the filtered, concentrated and sterilized aqueous subcomponent.

In some embodiments, the soluble coffee component is prepared by: pulverizing coffee beans to form a first pulverized coffee product; grinding coffee beans to form a second ground coffee product; extracting the second ground coffee product to form an extracted coffee product; combining the first pulverized coffee product with the extracted coffee product to form a first coffee blend; drying the first coffee blend to form a first dried coffee blend; and combining the first pulverized coffee product with the first dried coffee blend to form the soluble coffee component.

Some embodiments further comprise adding at least a portion of the fat subcomponent to the aqueous subcomponent before sterilizing the aqueous subcomponent, wherein the shelf-stable beverage comprises the soluble coffee component and the filtered, concentrated and sterilized aqueous subcomponent combined with at least a portion of the fat subcomponent, and wherein the raw unpasteurized liquid dairy component, the aqueous subcomponent and the fat subcomponent are not heated to a temperature above about 140° F.

In some embodiments, the raw unpasteurized liquid dairy component comprises raw unpasteurized milk.

In some embodiments, filtering the aqueous subcomponent comprises membrane filtration.

In some embodiments, the membrane filtration comprises at least one of microfiltration, reverse osmosis, nanofiltration and ultrafiltration.

In some embodiments, concentrating the aqueous subcomponent comprises at least one of reverse osmosis, nanofiltration and ultrafiltration.

In some embodiments, sterilizing the aqueous subcomponent comprises high pressure sterilization.

In some embodiments, the high pressure sterilization comprises temperature assisted pressure sterilization.

In some embodiments, the temperature assisted pressure sterilization is carried out at a temperature of from about 60° F. to about 140° F., a pressure of from about 3000 bar to about 9000 bar and for a time from about 30 seconds to about 10 minutes.

In some embodiments, the raw unpasteurized liquid dairy component, the aqueous subcomponent and the fat subcomponent are not heated to a temperature above about 140° F.

In some embodiments, the raw unpasteurized liquid dairy component, the aqueous subcomponent and the fat subcomponent are not heated to a temperature above about 135° F.

In some embodiments, the raw unpasteurized liquid dairy component, the aqueous subcomponent and the fat subcomponent are not heated to a temperature above about 130° F.

In some embodiments, the raw unpasteurized liquid dairy component, the aqueous subcomponent and the fat subcomponent are not heated to a temperature above about 120° F.

Some embodiments further comprise adding sugar to at least one of the soluble coffee component, the raw unpasteurized liquid dairy component, the aqueous subcomponent and the fat subcomponent.

Some embodiments further comprise adding flavoring to at least one of the soluble coffee component, the raw unpasteurized liquid dairy component, the aqueous subcomponent and the fat subcomponent.

Some embodiments further comprise adding to at least one of the soluble coffee component, the raw unpasteurized liquid dairy component, the aqueous subcomponent and the fat subcomponent, at least one of a coffee extract, concentrated coffee, dried coffee, coffee oils, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, a dry green coffee extract, a wet green coffee extract, pulverized coffee, roast coffee, roast and ground coffee, soluble coffee including pulverized coffee and an herbal extract.

Some embodiments relate to a shelf-stable beverage prepared by the method comprising separating a raw unpasteurized liquid dairy component into an aqueous subcomponent and a fat subcomponent; filtering the aqueous subcomponent; concentrating the aqueous subcomponent; sterilizing the aqueous subcomponent; and adding the aqueous subcomponent to a soluble coffee component, wherein the raw unpasteurized liquid dairy component, the aqueous subcomponent and the fat subcomponent are not pasteurized, and wherein the shelf-stable beverage comprises the soluble coffee component and the filtered, concentrated and sterilized aqueous subcomponent.

In some embodiments, the soluble coffee component is prepared by: pulverizing coffee beans to form a first pulverized coffee product; grinding coffee beans to form a second ground coffee product; extracting the second ground coffee product to form an extracted coffee product; combining the first pulverized coffee product with the extracted coffee product to form a first coffee blend; drying the first coffee blend to form a first dried coffee blend; combining the first pulverized coffee product with the first dried coffee blend to form the soluble coffee component.

Some embodiments further comprise adding at least a portion of the fat subcomponent to the aqueous subcomponent before sterilizing the aqueous subcomponent, wherein the shelf-stable beverage comprises the soluble coffee component and the filtered, concentrated and sterilized aqueous subcomponent combined with at least a portion of the fat subcomponent, and wherein the raw unpasteurized liquid dairy component, the aqueous subcomponent and the fat subcomponent have not been heated to a temperature above about 140° F.

In some embodiments, the raw unpasteurized liquid dairy component comprises raw unpasteurized milk.

In some embodiments, filtering the aqueous subcomponent comprises membrane filtration.

In some embodiments, the membrane filtration comprises at least one of microfiltration, reverse osmosis, nanofiltration and ultrafiltration.

In some embodiments, concentrating the aqueous subcomponent comprises at least one of reverse osmosis, nanofiltration and ultrafiltration.

In some embodiments, sterilizing the aqueous subcomponent comprises high pressure sterilization.

In some embodiments, the high pressure sterilization comprises temperature assisted pressure sterilization.

In some embodiments, the temperature assisted pressure sterilization is carried out at a temperature of from about 60° F. to about 140° F., a pressure of from about 3000 bar to about 9000 bar and for a time from about 30 seconds to about 10 minutes.

In some embodiments, the raw unpasteurized liquid dairy component, the aqueous subcomponent and the fat subcomponent are not heated to a temperature above about 140° F.

In some embodiments, the raw unpasteurized liquid dairy component, the aqueous subcomponent and the fat subcomponent are not heated to a temperature above about 135° F.

In some embodiments, the raw unpasteurized liquid dairy component, the aqueous subcomponent and the fat subcomponent are not heated to a temperature above about 130° F.

In some embodiments, the raw unpasteurized liquid dairy component, the aqueous subcomponent and the fat subcomponent are not heated to a temperature above about 120° F.

Some embodiments further comprise adding carbohydrates or sugar to at least one of the soluble coffee component, the raw unpasteurized liquid dairy component, the aqueous subcomponent and the fat subcomponent.

Some embodiments further comprise adding flavoring to at least one of the soluble coffee component, the raw unpasteurized liquid dairy component, the aqueous subcomponent and the fat subcomponent.

Some embodiments further comprise adding to at least one of the soluble coffee component, the raw unpasteurized liquid dairy component, the aqueous subcomponent and the fat subcomponent, at least one of a coffee extract, concentrated coffee, dried coffee, coffee oils, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, a dry green coffee extract, a wet green coffee extract, pulverized coffee, roast coffee, roast and ground coffee, soluble coffee including pulverized coffee and an herbal extract.

Some embodiments relate to a shelf-stable beverage comprising an aseptic dairy component; and a soluble coffee component, wherein the aseptic dairy component has undergone concentration, sterilization and drying, and wherein the aseptic dairy component has not been heated above about 80° F. more than one time during processing.

In some embodiments, the soluble coffee component comprises: a dry coffee extract component; and a pulverized coffee component, wherein the pulverized coffee component has not been extracted, and wherein the pulverized coffee component is added to the dry coffee extract component after the dry coffee extract is dried.

In some embodiments, the aseptic dairy component comprises an aqueous subcomponent and a fat subcomponent, wherein the aqueous subcomponent has been separated from a fat subcomponent before the aqueous subcomponent has undergone concentration.

In some embodiments, at least a portion of the fat subcomponent has been recombined with the aqueous subcomponent after the aqueous subcomponent has been concentrated and before the aqueous subcomponent has been dried.

In some embodiments, at least a portion of the fat subcomponent has been discarded after separation from the aqueous subcomponent.

In some embodiments, the concentration comprises at least one of membrane filtration and freeze concentration.

In some embodiments, the sterilization comprises pasteurization.

In some embodiments, the drying comprises at least one of freeze drying, filter mat drying, fluid bed drying, spray drying, thermal evaporation and zeodration.

In some embodiments, the membrane filtration comprises reverse osmosis filtration.

In some embodiments, the pasteurization comprises HTST (high temperature short time) pasteurization.

In some embodiments, the aseptic dairy component, the aqueous subcomponent and the fat subcomponent have not been heated above about 70° F. more than one time.

In some embodiments, the aseptic dairy component, the aqueous subcomponent and the fat subcomponent have not been heated above about 60° F. more than one time.

In some embodiments, the aseptic dairy component, the aqueous subcomponent and the fat subcomponent have not been heated above about 50° F. more than one time.

In some embodiments, the aseptic dairy component, the aqueous subcomponent and the fat subcomponent contain no artificial stabilizers or additives.

In some embodiments, the aqueous subcomponent and the fat subcomponent contain less than about 1 colony forming unit of spore forming bacteria per 1000 kg of the aseptic dairy component.

Some embodiments relate to a method of making a shelf-stable beverage, the method comprising separating a raw unpasteurized liquid dairy component into an aqueous subcomponent and a fat subcomponent; concentrating the aqueous subcomponent; sterilizing the aqueous subcomponent; drying the aqueous subcomponent; and adding the aqueous subcomponent to a soluble coffee component, wherein the raw unpasteurized liquid dairy component and the aqueous subcomponent are not heated to a temperature above about 80° F. more than one time during the method, and wherein the shelf-stable beverage comprises the soluble coffee component and the concentrated, sterilized and dried aqueous subcomponent.

In some embodiments, the soluble coffee component is prepared by pulverizing coffee beans to form a first pulverized coffee product; grinding coffee beans to form a second ground coffee product; extracting the second ground coffee product to form an extracted coffee product; combining the first pulverized coffee product with the extracted coffee product to form a first coffee blend; drying the first coffee blend to form a first dried coffee blend; combining the first pulverized coffee product with the first dried coffee blend to form the soluble coffee component.

Some embodiments further comprise adding at least a portion of the fat subcomponent to the aqueous subcomponent before drying the aqueous subcomponent, wherein the shelf-stable beverage comprises the soluble coffee component and the filtered, concentrated and dried aqueous subcomponent combined with at least a portion of the fat subcomponent, wherein the raw unpasteurized dairy component, the aqueous subcomponent and the fat subcomponent are not heated to a temperature above about 80° F. more than one time.

In some embodiments, the raw unpasteurized liquid dairy component comprises raw milk.

In some embodiments, concentrating the aqueous subcomponent comprises at least one of membrane filtration and freeze concentration.

In some embodiments, sterilizing the aqueous subcomponent comprises pasteurization.

In some embodiments, drying the aqueous subcomponent comprises at least one of freeze drying, filter mat drying, fluid bed drying, spray drying, thermal evaporation and zeodration.

In some embodiments, the membrane filtration comprises reverse osmosis filtration.

In some embodiments, the pasteurization comprises HTST pasteurization.

In some embodiments, the raw unpasteurized liquid dairy component, the aqueous subcomponent and the fat subcomponent are not heated above about 70° F. more than one time.

In some embodiments, the raw unpasteurized liquid dairy component, the aqueous subcomponent and the fat subcomponent are not heated above about 60° F. more than one time.

In some embodiments, the raw unpasteurized liquid dairy component, the aqueous subcomponent and the fat subcomponent are not heated above about 50° F. more than one time.

Some embodiments further comprise adding sugar to at least one of the soluble coffee component, the raw unpasteurized liquid dairy component, the aqueous subcomponent and the fat subcomponent.

Some embodiments further comprise adding flavoring to at least one of the soluble coffee component, the raw unpasteurized liquid dairy component, the aqueous subcomponent and the fat subcomponent.

Some embodiments further comprise adding to at least one of the soluble coffee component, the raw unpasteurized liquid dairy component, the aqueous subcomponent and the fat subcomponent, at least one of a coffee extract, concentrated coffee, dried coffee, coffee oils, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, a dry green coffee extract, a wet green coffee extract, pulverized coffee, roast coffee, roast and ground coffee, soluble coffee including pulverized coffee and an herbal extract.

Some embodiments relate to a shelf-stable beverage prepared by the method comprising separating a raw unpasteurized liquid dairy component into an aqueous subcomponent and a fat subcomponent; concentrating the aqueous subcomponent; sterilizing the aqueous subcomponent; drying the aqueous subcomponent; and adding the aqueous subcomponent to a soluble coffee component, wherein the raw unpasteurized liquid dairy component, the aqueous subcomponent and the fat subcomponent are not heated to a temperature above about 80° F. more than one time during the method, and wherein the shelf-stable beverage comprises the soluble coffee component and the concentrated, sterilized and dried aqueous subcomponent.

In some embodiments, the soluble coffee component is prepared by pulverizing coffee beans to form a first pulverized coffee product; grinding coffee beans to form a second ground coffee product; extracting the second ground coffee product to form an extracted coffee product; combining the first pulverized coffee product with the extracted coffee product to form a first coffee blend; drying the first coffee blend to form a first dried coffee blend; combining the first pulverized coffee product with the first dried coffee blend to form the soluble coffee component.

Some embodiments further comprise adding at least a portion of the fat subcomponent to the aqueous subcomponent before drying the aqueous subcomponent; wherein the shelf-stable beverage comprises the soluble coffee component and the filtered, concentrated and dried aqueous subcomponent combined with at least a portion of the fat subcomponent, wherein neither the aqueous subcomponent nor the fat subcomponent have been heated to a temperature above about 80° F. more than one time.

In some embodiments, the raw unpasteurized liquid dairy component comprises raw milk.

In some embodiments, concentrating the aqueous subcomponent comprises at least one of membrane filtration and freeze concentration.

In some embodiments, sterilizing the aqueous subcomponent comprises pasteurization.

In some embodiments, drying the aqueous subcomponent comprises at least one of freeze drying, filter mat drying, fluid bed drying, spray drying, thermal evaporation and zeodration.

In some embodiments, the membrane filtration comprises reverse osmosis filtration.

In some embodiments, the pasteurization comprises HTST pasteurization.

In some embodiments, the raw unpasteurized liquid dairy component, the aqueous subcomponent and the fat subcomponent are not heated above about 70° F. more than one time.

In some embodiments, the raw unpasteurized liquid dairy component, the aqueous subcomponent and the fat subcomponent are not heated above about 60° F. more than one time.

In some embodiments, the raw unpasteurized liquid dairy component, the aqueous subcomponent and the fat subcomponent are not heated above about 50° F. more than one time.

Some embodiments further comprise adding carbohydrates or sugar to at least one of the soluble coffee component, the raw unpasteurized liquid dairy component, the aqueous subcomponent and the fat subcomponent.

Some embodiments further comprise adding flavoring to at least one of the soluble coffee component, the raw unpasteurized liquid dairy component, the aqueous subcomponent and the fat subcomponent.

Some embodiments further comprise adding to at least one of the soluble coffee component, the raw unpasteurized liquid dairy component, the aqueous subcomponent and the fat subcomponent, at least one of a coffee extract, concentrated coffee, dried coffee, coffee oils, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, a dry green coffee extract, a wet green coffee extract, pulverized coffee, roast coffee, roast and ground coffee, soluble coffee including pulverized coffee and an herbal extract.

Some embodiments relate to a soluble coffee product, comprising: a dry coffee extract component; and a pulverized coffee component, wherein the pulverized coffee component has not been extracted, and wherein the pulverized coffee component is added to the dry coffee extract component after the dry coffee extract is dried.

In some embodiments, the pulverized coffee component is added to the dry coffee extract component both before and after the dry coffee extract is dried.

In some embodiments, the dry coffee extract component comprises from about 70% to about 90% of the soluble coffee product and, wherein the ground coffee component comprises from about 10% to about 30% of the soluble coffee product.

In some embodiments, the dry coffee extract component comprises from about 70% to about 99.9% of the soluble coffee product and, wherein the ground coffee component comprises from about 0.1% to about 30% of the soluble coffee product.

In some embodiments, the pulverized coffee component has a mean particle size of about 350 microns or less. In some embodiments, the pulverized coffee component has a median particle size of about 350 microns or less.

Some embodiments further comprise an additive selected from the group consisting of coffee oils, non-coffee oils, non-coffee aromas, and coffee aromas.

Some embodiments further comprise at least one selected from the group consisting of coffee extract, concentrated coffee, dried coffee, coffee oils, coffee aromas (distillates), flavor powders, flavor essences, carbohydrates, buffers, hydrocolloids, non-dairy ingredients, soy milk, almond milk, rice milk, corn syrup, fruit extracts, fruit purees, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, a dry green coffee extract, a wet green coffee extract and an herbal extract.

Some embodiments relate to a method of making a soluble coffee product, comprising: pulverizing coffee beans to form a first pulverized coffee product, grinding or pulverizing coffee beans to form a second ground or pulverized coffee product, extracting the second ground or pulverized coffee product to form an extracted coffee product, combining the first pulverized coffee product with the extracted coffee product to form a first coffee blend, drying the first coffee blend to form a first dried coffee blend, combining the first pulverized coffee product with the first dried coffee blend to form the soluble coffee product.

In some embodiments, the coffee is pre-frozen before being pulverized.

In some embodiments, the coffee is not pre-frozen before being pulverized, further comprising the step of refrigerating the grinding and pulverizing machinery.

In some embodiments, the coffee is pre-frozen, further comprising the step of refrigerating the grinding and pulverizing machinery.

Some embodiments further comprise the step of adding to the first coffee blend at least one selected from the group consisting of coffee extract, concentrated coffee, dried coffee, coffee oils, coffee aromas (distillates), flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, dry green coffee extract, wet green coffee extract and an herbal extract.

In some embodiments, the grinding or pulverizing is carried out at a temperature of from about 0° C. to about 60° C. In some other embodiments, the grinding or pulverizing is carried out at from about 5° C. to about 30° C. In still other embodiments, the grinding or pulverizing is carried out at from about 20° C. to about 50° C.

Some embodiments further comprise the step of refrigerating grinding and pulverizing machinery to a temperature of about −5° C. or less.

Some embodiments relate to a method of making a soluble coffee product, comprising: grinding or pulverizing coffee beans to form a first ground or pulverized coffee product, grinding or pulverizing coffee beans to form a second ground or pulverized coffee product, pulverizing coffee beans to form a third pulverized coffee product, extracting the first ground or pulverized coffee product and separating the first ground or pulverized coffee product into a coffee flavor component and a coffee aroma component, extracting the second ground or pulverized coffee product to form a first extracted coffee product, combining the coffee aroma component with the extracted coffee product to form a first coffee blend, combining the first coffee blend with the third pulverized coffee product to form a second coffee blend, drying the second coffee blend to form a first dried coffee blend, combining the third pulverized coffee with the first dried coffee blend to form the soluble coffee.

In some embodiments, the coffee is pre-frozen before the pulverizing.

In some embodiments, the coffee is not pre-frozen before the pulverizing, further comprising the step of refrigerating the grinding and pulverizing machinery.

Some embodiments further comprise the step of adding to the first coffee blend at least one selected from the group consisting of coffee extract, concentrated coffee, dried coffee, coffee oils, coffee aromas (distillates), flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, dry green coffee extract, wet green coffee extract and an herbal extract.

In some embodiments, the pulverizing and grinding is carried out at a temperature of from about 20° C. to about 50° C.

In some embodiments, the pulverizing and grinding is carried out at a temperature of less than about 1° C.

In some embodiments, the temperature of the equipment and coffee product in each step is about −5° C. or less.

Some embodiments relate to a soluble coffee product prepared by a method comprising: pulverizing coffee beans to form a first pulverized coffee product grinding or pulverizing coffee beans to form a second ground or pulverized coffee product, extracting the second ground or pulverized coffee product to form an extracted coffee product, combining the first pulverized coffee product with the extracted coffee product to form a first coffee blend, drying the first coffee blend to form a first dried coffee blend, combining the first pulverized coffee product with the first dried coffee blend to form the soluble coffee product.

In some embodiments, the dry coffee extract component comprises from about 70% to about 90% of the soluble coffee product and, wherein the ground coffee component comprises from about 10% to about 30% of the soluble coffee product.

In some embodiments, the dry coffee extract component comprises from about 70% to about 99.9% of the soluble coffee product and, wherein the ground coffee component comprises from about 0.1% to about 30% of the soluble coffee product.

In some embodiments, the ground coffee component has a mean particle size of about 350 microns or less. In some embodiments, the pulverized coffee component has a median particle size of about 350 microns or less.

Some embodiments further comprise at least one selected from the group consisting of coffee oils, non-coffee oils, non-coffee aromas, and coffee aromas.

Some embodiments further comprise at least one additive selected from the group consisting of coffee extract, concentrated coffee, dried coffee, coffee oils, coffee aromas (distillates), flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, dry green coffee extract, wet green coffee extract and an herbal extract.

Some embodiments relate to a method of making a soluble coffee product, comprising: grinding or pulverizing coffee beans to form a first ground or pulverized coffee product, grinding or pulverizing coffee beans to form a second ground or pulverized coffee product, pulverizing coffee beans to form a third pulverized coffee product, extracting the first ground or pulverized coffee product and separating the first ground or pulverized coffee product into at least a first extracted component and a extracted second component, extracting the second ground or pulverized coffee product to form a first extracted coffee product, combining the coffee aroma component with the extracted coffee product to form a first coffee blend, combining the first coffee blend with the third pulverized coffee product to form a second coffee blend, drying the second coffee blend to form a first dried coffee blend, combining the third pulverized coffee with the first dried coffee blend to form the soluble coffee.

In some embodiments, the first extracted component is a flavor component and the second extracted component is an aroma component.

In some embodiments, the coffee is pre-frozen before the pulverizing.

In some embodiments, the coffee is not pre-frozen before the pulverizing, further comprising the step of refrigerating the grinding and pulverizing machinery.

Some embodiments further comprise the step of adding to the first coffee blend at least one selected from the group consisting of coffee extract, concentrated coffee, dried coffee, coffee oils, coffee aromas (distillates), flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, dry green coffee extract, wet green coffee extract and an herbal extract.

In some embodiments, the pulverizing and grinding is carried out at a temperature of from about 20° C. to about 50° C.

In some embodiments, the pulverizing and grinding is carried out at a temperature of less than about 1° C.

In some embodiments, the temperature of the equipment and coffee product in each step is about −5° C. or less.

Some embodiments further comprise the step of adding the first extracted component or the second extracted component to the first dried coffee blend.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A shelf-stable dairy product comprising:
an aseptic liquid dairy component comprising an aqueous subcomponent, wherein the aqueous subcomponent has been separated from a fat subcomponent, wherein the aqueous subcomponent has undergone filtration, concentration and sterilization, and
wherein the aqueous subcomponent has not been pasteurized.

2. The shelf-stable dairy product of claim 1, wherein at least a portion of the fat subcomponent has been recombined with the aqueous subcomponent after the aqueous subcomponent has been concentrated and before the aqueous subcomponent has been sterilized.

3. The shelf-stable dairy product of claim 1, wherein at least a portion of the fat subcomponent has been discarded after separation from the aqueous subcomponent.

4. The shelf-stable dairy product of claim 1, wherein the concentration comprises at least one of membrane filtration and freeze concentration.

5. The shelf-stable dairy product of claim 1, wherein the sterilization comprises high pressure sterilization.

6. The shelf-stable dairy product of claim 1, wherein the filtration comprises membrane filtration.

7. The shelf-stable dairy product of claim 2, wherein aseptic liquid dairy component, the aqueous subcomponent and the fat subcomponent have not been heated above about 140° F.

8. The shelf-stable dairy product of claim 2, wherein aseptic liquid dairy component, the aqueous subcomponent and the fat subcomponent have not been heated above about 135° F.

9. The shelf-stable dairy product of claim 2, wherein aseptic liquid dairy component, the aqueous subcomponent and the fat subcomponent have not been heated above about 130° F.

10. The shelf-stable dairy product of claim 2, wherein aseptic liquid dairy component, the aqueous subcomponent and the fat subcomponent have not been heated above about 120° F.

11. The shelf-stable dairy product of claim 4, wherein the membrane filtration comprises at least one of nanofiltration, microfiltration, reverse osmosis and ultrafiltration.

12. The shelf-stable dairy product of claim 5, wherein the high pressure sterilization comprises temperature assisted pressure sterilization.

13. The shelf-stable dairy product of claim 6, wherein the membrane filtration comprises at least one of nanofiltration, microfiltration, reverse osmosis and ultrafiltration.

14. The shelf-stable dairy product of claim 2, wherein neither the aqueous subcomponent nor the fat subcomponent contain artificial stabilizers or additives.

15. The shelf-stable dairy product of claim 2, wherein the aqueous subcomponent and the fat subcomponent contain less than about 1 colony forming unit of spore forming bacteria per 1000 kg of the aseptic liquid dairy component.

16. The shelf-stable dairy product of claim 1, further comprising a coffee component.

17. The shelf-stable dairy product of claim 16, wherein the coffee component is a soluble coffee component.

18. A method of making a shelf-stable dairy product comprising:
separating a raw unpasteurized liquid dairy component into an aqueous subcomponent and a fat subcomponent;
filtering the aqueous subcomponent;
concentrating the aqueous subcomponent; and
sterilizing the aqueous subcomponent,
wherein the raw unpasteurized liquid dairy component, the aqueous subcomponent and the fat subcomponent are not pasteurized, and
wherein the shelf-stable dairy product comprises the filtered, concentrated and sterilized aqueous subcomponent.

19. The method of claim 18, further comprising adding at least a portion of the fat subcomponent to the aqueous subcomponent before sterilizing the aqueous subcomponent,
wherein the shelf-stable dairy product comprises the filtered, concentrated and sterilized aqueous subcomponent combined with at least a portion of the fat subcomponent, and
wherein neither the aqueous subcomponent nor the fat subcomponent have been heated to a temperature above about 140° F.

20. The method of claim 18, wherein the raw unpasteurized liquid dairy component comprises raw unpasteurized milk.

21. The method of claim 18, wherein filtering the aqueous subcomponent comprises membrane filtration.

22. The method of claim 21, wherein the membrane filtration comprises at least one of nanofiltration, microfiltration, reverse osmosis and ultrafiltration.

23. The method of claim 18, wherein concentrating the aqueous subcomponent comprises at least one of reverse osmosis, microfiltration and ultrafiltration.

24. The method of claim 18, wherein sterilizing the aqueous subcomponent comprises high pressure sterilization.

25. The method of claim 24, wherein the high pressure sterilization comprises temperature assisted pressure sterilization.

26. The method of claim 25, wherein the temperature assisted pressure sterilization is carried out at a temperature of from about 60° F. to about 140° F., a pressure of from about 3000 bar to about 9000 bar and for a time from about 30 seconds to about 10 minutes.

27. The method of claim 18, wherein the raw unpasteurized liquid dairy component, the aqueous subcomponent and the fat subcomponent are not heated to a temperature above about 140° F.

28. The method of claim 18, wherein the raw unpasteurized liquid dairy component, the aqueous subcomponent and the fat subcomponent are not heated to a temperature above about 135° F.

29. The method of claim 18, wherein the raw unpasteurized liquid dairy component, the aqueous subcomponent and the fat subcomponent are not heated to a temperature above about 130° F.

30. The method of claim 18, wherein the raw unpasteurized liquid dairy component, the aqueous subcomponent and the fat subcomponent are not heated to a temperature above about 120° F.

31. The method of claim 18, further comprising adding at least one carbohydrate to at least one of the raw unpasteurized liquid dairy component, the aqueous subcomponent and the fat subcomponent.

32. The method of claim 18, further comprising adding flavoring to at least one of the raw unpasteurized liquid dairy component, the aqueous subcomponent and the fat subcomponent.

33. The method of claim 18, further comprising adding to at least one of the raw unpasteurized liquid dairy component, the aqueous subcomponent and the fat subcomponent, at least one of a coffee extract, concentrated coffee, dried coffee, soluble coffee, coffee oils, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, a dry green coffee extract, a wet green coffee extract, pulverized coffee, ground coffee and an herbal extract.

34. A shelf-stable beverage comprising a dairy product prepared by the method comprising:
separating a raw unpasteurized liquid dairy component into an aqueous subcomponent and a fat subcomponent;
filtering the aqueous subcomponent;
concentrating the aqueous subcomponent; and
sterilizing the aqueous subcomponent,
wherein the raw unpasteurized liquid dairy component, the aqueous subcomponent and the fat subcomponent are not pasteurized, and
wherein the shelf-stable dairy product comprises the filtered, concentrated and sterilized aqueous subcomponent.

35. The shelf-stable beverage of claim 34, further comprising adding at least a portion of the fat subcomponent to the aqueous subcomponent before sterilizing the aqueous subcomponent,
wherein the shelf-stable dairy product comprises the filtered, concentrated and sterilized aqueous subcomponent combined with at least a portion of the fat subcomponent,
and wherein neither the aqueous subcomponent nor the fat subcomponent have been heated to a temperature above about 140° F.

36. The shelf-stable beverage of claim 34, wherein the raw unpasteurized liquid dairy component comprises raw unpasteurized milk.

37. The shelf-stable beverage of claim 34, wherein filtering the aqueous subcomponent comprises membrane filtration.

38. The shelf-stable beverage of claim 37, wherein the membrane filtration comprises at least one of nanofiltration, microfiltration, reverse osmosis and ultrafiltration.

39. The shelf-stable beverage of claim 34, wherein concentrating the aqueous subcomponent comprises at least one of microfiltration, reverse osmosis and ultrafiltration.

40. The shelf-stable beverage of claim 34, wherein sterilizing the aqueous subcomponent comprises high pressure sterilization.

41. The shelf-stable beverage of claim 40, wherein the high pressure sterilization comprises temperature assisted pressure sterilization.

42. The shelf-stable beverage of claim 40, wherein the temperature assisted pressure sterilization is carried out at a temperature of from about 60° F. to about 140° F., a pressure of from about 3000 bar to about 9000 bar and for a time from about 30 seconds to about 10 minutes.

43. The shelf-stable beverage of claim 34, wherein the raw unpasteurized liquid dairy component, the aqueous subcomponent and the fat subcomponent are not heated to a temperature above about 140° F.

44. The shelf-stable beverage of claim 34, wherein the raw unpasteurized liquid dairy component, the aqueous subcomponent and the fat subcomponent are not heated to a temperature above about 135° F.

45. The shelf-stable beverage of claim 34, wherein the raw unpasteurized liquid dairy component, the aqueous subcomponent and the fat subcomponent are not heated to a temperature above about 130° F.

46. The shelf-stable beverage of claim 34, wherein the raw unpasteurized liquid dairy component, the aqueous subcomponent and the fat subcomponent are not heated to a temperature above about 120° F.

47. The shelf-stable beverage of claim 34, further comprising adding sugar to at least one of the raw unpasteurized liquid dairy component, the aqueous subcomponent and the fat subcomponent.

48. The shelf-stable beverage of claim 34, further comprising adding flavoring to at least one of the raw unpasteurized liquid dairy component, the aqueous subcomponent and the fat subcomponent.

49. The shelf-stable beverage of claim 34, further comprising adding to at least one of the raw unpasteurized liquid dairy component, the aqueous subcomponent and the fat subcomponent, at least one of a coffee extract, concentrated coffee, dried coffee, soluble coffee, coffee oils, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, lycopene, selenium, a beta-carotene, resveratrol, inulin, beta glucan, 1-3, 1-6-beta-glucan, barley beta-glucan, barley b-glucan, a vegetable extract, a dry green coffee extract, a wet green coffee extract, pulverized coffee, ground coffee and an herbal extract.

50. A system for preparing a shelf-stable dairy product comprising:
a component for separating a raw unpasteurized dairy substance into an aqueous substance and a fat substance;
a component for concentrating the aqueous substance;
a component for filtering the aqueous substance; and
a component for sterilizing the aqueous substance,
wherein the raw unpasteurized dairy substance, the aqueous substance and the fat substance are not heated to a temperature above about 140° F.

51. The system of claim 50, further comprising a component for adding coffee to the aqueous substance.

52. The system of claim 50, wherein the coffee comprises a soluble coffee.

53. The system of claim 50, further comprising a component for adding at least a portion of the separated fat substance to the aqueous substance.
